(19) United States
(12) Patent Application Publication
(10) Pub. No.: US 2011/0166939 A1
(43) Pub. Date: Jul. 7, 2011

(54) SYSTEMS AND METHODS FOR INTEGRATING DATA MINING AND OTHER MARKETING TECHNIQUES WITH FANTASY SPORTS CONTEST APPLICATIONS

(75) Inventors: William Junkin, Corona Del Mar, CA (US); Dave Barber, Tulsa, OK (US)

(73) Assignee: Rovi Technologies Corporation, Santa Clara, CA (US)

(21) Appl. No.: 12/902,640

(22) Filed: Oct. 12, 2010

Related U.S. Application Data
(63) Continuation of application No. 10/234,869, filed on Aug. 30, 2002, now abandoned.

(51) Int. Cl. G06Q 30/00; G06F 19/00

(52) U.S. Cl. 705/14.61; 705/14.49; 700/91

(57) ABSTRACT

Systems and methods are provided for integrating quantitative marketing techniques in fantasy sports contest applications and other contest applications to provide personalized advertisements and other marketing related communications and/or content. The fantasy sports contests application may create user profiles to store various information associated with users. Information associated with users may be provided by the users or automatically gathered by the application through various channels such as external consumer databases. The application may employ tests such as personality tests and other types of predictive games to collect additional user information. The application may also link user profiles to users clusters including other users having similar characteristics.

### CROSS-REFERENCE TO RELATED APPLICATIONS

This application claims priority to and the benefit of U.S. patent application Ser. No. 10/234,869, filed Aug. 30, 2002 and entitled “Systems and methods for integrating data mining and other marketing techniques with fantasy sports contest applications”, the entire contents of which are incorporated herein by reference.

### BACKGROUND OF THE INVENTION

This invention relates to systems and methods for providing a fantasy sports contest application, and more particularly, this invention relates to systems and methods for integrating data mining and other marketing techniques with fantasy sports contest applications and related systems.

Athletic endeavors have long supported a broad range of secondary competitions, which include wagering on the outcome of particular games and wagering on the performance of a particular player.

In known fantasy sports contests, a user selects a roster, a team, a particular individual, or a group of individuals in an athletic contest. The user is given the ability to take on the role of a fictional general manager with powers which may include the ability to draft, trade, dismiss and otherwise manage the player or players on the user's fantasy sports team.

Conventionally, a fantasy sports contest provider, a league commissioner, or a combination of the two, sets the rules under which a group of fantasy sports users compete against each other in a fantasy sports contest. For example, for every goal scored in real-life by a member of the user's fantasy soccer team, five points may be awarded to the user in the fantasy sports contest.

The real-life athletic events upon which a fantasy sports contest may be based are varied, and typically involve selecting players from real-life team sports (e.g., football, baseball, basketball, hockey, soccer or rugby), selecting players from real-life individual sports (e.g., golf, tennis or automotive racing), or selecting participants from competitions involving animals (e.g., horse and dog racing). The user's selections are typically stored in the user's fantasy sports contest roster. The performance of these selections in real-life competitions collectively determines the user's performance in the fantasy sports contest.

A fantasy sports contest goes beyond traditional one-time wagering applications (e.g., selecting picks for the winners of a weekend's football games or picking who will win a most valuable player award). In a conventional fantasy sports contest, a user is able to modify his selections, albeit with the possibility of restrictions, over time (e.g., swapping race cars with another user midway through an automotive race or making trades during the week in a fantasy football contest).

A user of a fantasy sports contest application typically registers or otherwise notifies the fantasy sports contest provider of his intention to participate in a contest. After joining, the user typically visits (or connects to) the fantasy sports contest application numerous times during the course of the contest. These visits create opportunities to market products, services, or any other suitable merchandises to the user.

Accordingly, it is desirable to provide improved ways for providing personalized advertisements and other marketing-related content to the user.

### SUMMARY OF THE INVENTION

It is therefore an object of the present invention to provide improved ways for providing personalized one-to-one marketing-related content to the user.

This and other objects of the invention are accomplished in accordance with the principles of the present invention by integrating data mining and other marketing techniques in fantasy sports contest applications and other related systems.

The present invention is primarily described herein in terms a fantasy sports contest application that provides personalized advertisements and other marketing-related content to the user. It will be understood that advertisements may include any suitable forms of communication to the user using any suitable methodologies. The advertisements may include but are not limited to electronic communications, wireless communications, facsimiles, regular postal mail, any other suitable form of communication, or any combination thereof.

In some embodiments of the present invention, the fantasy sports contest application may create user profiles to store user information associated with registered users or users that the application is able to identify. User information may include, for example, demographic information (e.g., age, sex, address, marital status, etc.), psychographic information (e.g., personality, habits, etc.), behavioral information (e.g., purchase history, Internet activities, etc.), systems information (e.g., set-top box, television, operating system, browser, Internet connection, etc.), or any other suitable information specific to a user. User information may be provided by the user, (e.g., on a registration form), extracted from external databases (e.g., consumer databases maintained by companies such as Donnelley Marketing, which has a place of business at Greenwich, Conn.), collected as clickstream data (e.g., from cookies installed on the user's browser, from log files that record user interactions with the fantasy sports contest application, or from any other suitable storage of such data), collected from any other suitable information sources, or collected by any combination of approaches thereof.

The fantasy sports contest application may search external databases (e.g., consumer databases maintained by any company that collects and maintains data on individuals or households such as Donnelley Marketing, which has a place of business at Greenwich, Conn.) for additional information associated with a registered user. In instances in which user consent is required for such a search, the fantasy sports contest application may request consent from the user before performing the search. The fantasy sports contest application may offer special incentives (e.g., coupons, free services, products, etc.) for example, during the registration process, via email, via snail mail, during user interaction with certain fantasy sports contest information, or using any other suitable approach, to encourage users to give any required consent.

The resulting user profiles include extensive amounts of user information that may allow various marketing analysis to be performed. In one suitable approach, the fantasy sports contest application may segment the users into unique clusters in which users exhibit similar characteristics. These characteristics may be, for example, demographics, psychographics, behaviors, systems, any other suitable characteristic, or any combination thereof. Such segmentation may attract, for example, various marketers who are interested in targeting more specific groups of users.

In some embodiment of the present invention, the fantasy sports contest application may associate the user's profile with one or more user clusters. The fantasy sports contest application may create explicit association between the user's profile and a cluster by, for example, storing an id of the user's user profile in a representative profile created to represent the particular user cluster.

The fantasy sports contest application may also employ various recreational methods to obtain additional information about the user. The additional information may be information that is hard to obtain through more direct channels described above. The fantasy sports contest application may analyze such information to record the user's life-style characteristics such as, price conscious, homebody, dieter, information seeker, or any other suitable characteristics. The fantasy sports contest application may then construct algorithms or implement other methods using these life-style characteristics to target advertisements and other marketing content to the user.

In some embodiments of the present invention, the fantasy sports contest application may provide tests such as personality tests and other types of interactive games to collect additional user information for the user profile. The additional information may also be used to confirm the validity of information already stored in the user profile. For example, personality tests and other types of games may request the user to supply demographic information. Because users may provide accurate demographic information while completing a personality test in exchange for a more accurate predication, the fantasy sports contest application may use information supplied to confirm or correct information stored in the user profile.

As another example, the fantasy sports contest application may employ tests or games to help predict psychographic or behavioral information about the user. In these tests, the user may be asked to supply various personal information. The fantasy sports contest application may provide a personality profile to the user based on the personal information supplied to satisfy the user's curiosity as well as to provide valuable information for the user profile (e.g., a test to determine the type of automobile that may be suitable for or desired by the user). For example, based on a combination of the user's answers to a survey about eating habits and other stored user information (e.g., sex, age, geographical location, purchase behavior, etc), the fantasy sports contest application may predict that the user is inclined to be a dieter. The fantasy sports contest application may display this prediction to the user. At the same time, the fantasy sports contest application may insert information inferred from this test into the user profile. Information inferred from such a prediction may be, for example, the user may be more socially active, the user may have a tendency to try new products, or any other suitable information that may be inferred.

In some embodiments of the present invention, the fantasy sports contest application may provide recreational or helpful tests that are designed to perform conjoint analysis on specific products or product categories. Such tests may be intended, for example, to help the user reach a specific decision such as what type of car to purchase. Results from these tests may also be added to the information in the user information database. Conjoint analysis is a technique that provides a series of dynamic questions which forces the user to make choices regarding which product attributes, characteristics, features and benefits are of greatest importance as the user proceeds through the questions. The end result may be a product selection that represents what is most important to the user.

For example, the fantasy sports contest application may prompt the user, who is trying to determine which car to purchase, to choose between, for example, price and warrant period, brand name and price, specific features and price, warranty period and color, etc. The process is based on a dynamic analysis where new questions are asked based on answers to previous questions the user has provided.

In some embodiments of the present invention, the fantasy sports contest application may also monitor and record the user's selections and other interactions with the fantasy sports contest application and integrate such information and any analysis based on such information into the user profile.

In some embodiments of the present invention, the fantasy sports contest application may target advertisements and recommend products and services to the user based on trends observed in a particular cluster, in which the user is a member. The fantasy sports contest application may determine popular advertisements, products, services, or any other suitable marketing content that have aroused significant interest in the cluster within a period of time (e.g., within a day, within the last week, within the last month, etc.). The fantasy sports contest application may then identify users within the cluster who have not being exposed to these popular advertisements, products, service, or any other suitable market content. These content may subsequently be displayed to the identified users.

In some embodiments of the present invention, the fantasy sports contest application may associate advertisements with various pre-identified attributes of contest element such as an athlete, a team, a location, a competition, or any other suitable contest element. The fantasy sports contest application may then display these advertisements to the user when contest information associated with the contest element is shown. For example, an athlete (e.g., Tiger Woods) may be a spokesperson for a particular product (e.g., Buick automobile). Accordingly, the fantasy sports contest application may associate advertisements for Buick automobile with the athlete. The Buick advertisements may be shown by the fantasy sports contest application whenever information associated with the athlete is displayed (e.g., contest screen displaying the athlete's biographical information, scores associated with the athlete, or any suitable display having information related to the athlete).

Advertisements may also be grouped together. The fantasy sports contest application may show the advertisements from a group in a specific order and sequence determined, for example, by the advertiser. Advertisements and other marketing communication delivery techniques and delivery methods may include telemarketing and other suitable techniques and methods.

The fantasy sports contest application may also associate advertisements to each other. When a particular advertisement is selected by the user, the fantasy sports contest application may display or schedule to display various advertisements associated with the selected advertisement.

In some embodiments of the present invention, the fantasy sports contest application may associate advertisements with contest screens based on various categories of pre-defined characteristics. The fantasy sports contest application may first categorize an advertisement by, for example, intended audience, intended viewing duration, intended reach, any other suitable characteristic, or any combination thereof. In a more specific example, the cost of viewing impressions may be stored by the fantasy sports contest application. Using this information and information on an advertiser's budget, the fantasy sports contest application may display advertisements for the advertiser costing up to a budgeted amount. The fantasy sports contest application may accord appropriate codes to the advertisement to represent each categorization.

Similarly, the fantasy sports contest application may categorize contest screens (e.g., login screen, team statistics screen, athlete biography screen, etc.) by, for example, average number of times accessed per period(e.g., per day, per week, etc.), audience, average viewing duration, sequential relation to other contest screens, commonly associated user behavior, any other suitable characteristics, or any combination thereof. The fantasy sports contest application may accord appropriate codes corresponding to those associated with advertisements to contest screens. The fantasy sports contest application may then use these corresponding codes to match and display advertisements on contest screens associated with similar codes.

In some embodiments of the present invention, the fantasy sports contest application may identify a receptive audience for an advertisement using a predictive model. In one approach, an advertiser may provide a set of characteristics of a target audience for a particular advertisement. Alternatively, the fantasy sports contest application may determine a set of characteristics for the advertisement based on a known audience for similar products or services. The fantasy sports contest application may create a predictive model to match or infer the key characteristics determined using user attributes in user profiles, analytical algorithms constructed based on user attributes in user profiles, or attributes in external databases. The fantasy sports contest application may then search user profiles and external databases based on the predicative model to identify a likely receptive audience for the advertisement.

For example, the fantasy sports contest application may determine that the most predicative set of characteristics of an audience for a floral arrangement advertisement includes, for example, recently engaged couples that are of a certain age, income, religious belief, etc. The fantasy sports contest application may then create a predictive model to search for people who have recently registered with wedding registries because such information infers that these people are likely to be wed. The fantasy sports contest application may perform searches based on this predictive model in user profiles and external databases to identify a likely receptive audience for the advertisement.

As another example, the fantasy sports contest application may access external databases having specific user information (e.g., a database including information about people who have recently moved). The fantasy sports contest application may cross-reference users of the fantasy sports contest application or other related systems with records in these databases. When a match is detected, the fantasy sports contest application may target advertisements tailored to new residents (e.g., advertisements for local dry cleaners, cable company, take-out restaurants, supermarkets, and any other suitable establishment where an initial customer relationship is valued) to the user.

In some embodiments of the present invention, the fantasy sports contest application may construct metrics to measure the degree of success associated with various efforts to target users and to induce them to purchase or otherwise consume products, services, or any other suitable items, that are presented or promoted to the users.

Initially, the fantasy sports contest application may determine whether any given user is an untargeted user, a suspect, a prospect, a lead, a buyer, or a heavy buyer for any given product, service, or any other suitable item that the user may purchase or otherwise consume. For example, the fantasy sports contest application may identify a user as a lead based on information provided by a retailer indicating previous interactions between the user and the retailer (e.g., the user requesting additional information about a product or service). In response to determining such information, the fantasy sports contest application may present targeted advertisements or any other suitable forms of communications that are related to the user's interest to the user. The fantasy sports contest application may subsequently monitor any interaction between the user and the presented targeted advertisements or any other suitable forms of communications. Various advertising approaches, delivery methods, or offers, may be presented to the user based on the user's interactions. For example, if the user showed no interest in a regular on-screen advertisement although the user has previously shown interest in the product in the on-screen advertisement, the fantasy sports contest application may send the user an email including a similar advertisement or any other form of communication for the product to see if the user would respond via email.

In some embodiments of the present invention, the fantasy sports contest application or another application may apply metrics to user information which is collected. For example, information may be collected from external databases about automobile registrations. An advertiser of high-end automobiles might wish to target consumers who have already registered high-end automobiles in the belief that they may be more likely to purchase automobiles of the same type. Other criteria may also be used. For example, a high-end automobile dealership may be interested in households that have registered sports utility vehicles.

From the information collected externally, a list of sales leads (e.g., users) may be fed into the application. Leads may also be gathered from information stored in the user information database described herein. For example, the user's answers to the recreational or helpful tests may be used.

For the users who are now indicated to be leads, the fantasy sports contest application may target advertisements and other communications to those users. For example, the fantasy sports contest application may target interactive communications to the user.

The user information database may track information on the users who have been sent a particular communication as well as how often the user has been sent a communication (e.g., the fantasy sports contest application may track the frequency of a particular advertising impression that is shown to a user). The fantasy sports contest application may also send information about leads to an external party (e.g., the seller of products or services). The external party may then choose to send additional communications to a user. For example, the party may attempt to communicate with the user through emails, regular postal mail, telemarketing calls, or any other appropriate means. The external party may send information concerning the frequency and means by which it communicates with a user to the user information database of the present invention (thus allowing a later analysis of how individual consumers have been approached).

Based on the above mentioned information or any other suitable information resulted from any other suitable approaches, the fantasy sports contest application may now construct metrics to measure the degree of success associated with the various efforts to target the users and to induce the users to purchase or otherwise consume products, services, or any other suitable item, that are presented to the user.

As an example, the fantasy sports contest application may identify the number or percentage of users that have progressed to become consumers, in response to being exposed to, for example, certain advertisements or other suitable forms of communication.

As another example, the fantasy sports contest application may identify and compare user responses associated with different advertisements or other suitable forms of communications that target similar users or represent similar products, services, or any other suitable items, in order to, for example, identify creative approaches for targeting users that are superior to others.

As another example, the fantasy sports contest application may identify and compare user responses associated with different offers or any other suitable methods of enticing the user to purchase or otherwise consume products, services, or any other suitable items, in order to, for example, identify methods for making offers to the users that are superior to others.

As yet another example, the fantasy sports contest application may identify and compare a particular user's responses associated with different delivery methods or delivery vehicles (e.g., television, radio, email, phone, fax, regular postal mail, etc.) for targeting or otherwise reaching the user, in order to, for example, identify delivery methods or vehicles that are superior to others for that particular user.

The fantasy sports contest application may further combine, modify, or otherwise manipulate the various attributes that are integrated in user profiles, external databases, or extracted from any other suitable data sources, to identify, measure, or evaluate the various aspects involved in targeting advertisements or any other suitable forms of communications to the users.

Information of which interactive displays lead to higher response rates may be measured and reported back to the sponsor.

Although there is value in tracking the manner, frequency in which communications are sent and the responses to such communications, information on whether a user has completed a transaction to purchase the related product or service is of particular importance in order to measure the success of a marketing campaign.

Vendors such as MasterCard now sell line item market data information for credit card purchases for their users. For example, the data may report the brand, model and stock keeping units (SKU's) of the individual items purchased in connection with a single credit card transaction. In addition, supermarkets and drug stores have affinity discount cards which are connected to systems that record the individual items purchased by a user for those transactions in which the user has disclosed his or her affinity discount card.

The market data information can be fed to the user information database. If there is a match between a user already profiled in the database and data for a person in the market data, the fantasy sports contest application may store one or more pieces of information about the user's purchasing behavior from the market data information feed.

From the collected information, metrics may be run to determine the communications and methods of communication which enjoy the greatest levels of success for a particular user. The metrics may also sub-categorize the information (e.g., for books, emailed coupons to purchase books online may lead to more purchases than other types of communications for that user, and for automobiles, information sent by regular postal mail might be the most effective means of communication). Based on what is determined from the metrics analysis for a particular user of what leads to the greatest amount of sales, a marketer may tailor the future composition and method of delivery of future communications directed to particular user.

Based on the above mentioned information or any other suitable information resulted from any other suitable approaches, the fantasy sports contest application may now construct metrics to measure the degree of success associated with the various efforts to target the users and to induce the users to purchase or otherwise consume products, services, or any other suitable item, that are presented to the user.

As an example, the fantasy sports contest application may identify the number or percentage of users that have progressed to become consumers, in response to being exposed to, for example, certain advertisements or other suitable forms of communication.

As another example, the fantasy sports contest application may identify and compare user responses associated with different advertisements or other suitable forms of communications that target similar users or represent similar products, services, or any other suitable items, in order to, for example, identify creative approaches for targeting users that are superior to others.

As another example, the fantasy sports contest application may identify and compare user responses associated with different offers or any other suitable methods of enticing the user to purchase or otherwise consume products, services, or any other suitable items, in order to, for example, identify methods for making offers to the users that are superior to others.

As yet another example, the fantasy sports contest application may identify and compare a particular user's responses associated with different delivery methods or delivery vehicles (e.g., television, radio, email, phone, fax, regular postal mail, etc.) for targeting or otherwise reaching the user, in order to, for example, identify delivery methods or vehicles that are superior to others for that particular user.

The fantasy sports contest application may further combine, modify, or otherwise manipulate the various attributes that are integrated in user profiles, external databases, or extracted from any other suitable data sources, to identify, measure, or evaluate the various aspects involved in targeting advertisements or any other suitable forms of communications to the users.

Further features of the invention, its nature and various advantages will be made apparent from the accompanying drawings and the following detailed description.

### BRIEF DESCRIPTION OF THE DRAWINGS

FIG. 1 is a diagram of an illustrative client/server system in accordance with one embodiment of the present invention;

FIG. 2 is a diagram of an illustrative interactive television system in accordance with one embodiment of the present invention;

FIG. 3 is a diagram of an illustrative interactive television system having network nodes in accordance with one embodiment of the present invention;

FIG. 4 is an illustrative user registration screen in accordance with one embodiment of the present invention;

FIG. 5 is an illustrative user registration screen having a request for consent pop up screen in accordance with one embodiment of the present invention;

FIG. 6 is a flow chart of illustrative steps involved in creating a user profile in accordance with one embodiment of the present invention;

FIG. 7 is a flow chart of illustrative steps involved in receiving user registration information in accordance with one embodiment of the present invention;

FIG. 8 is a flow chart of illustrative steps involved in collecting clickstream data in accordance with one embodiment of the present invention;

FIG. 9 is an illustrative fantasy sports display screen having a personality test in accordance with one embodiment of the present invention;

FIG. 10 is a flow chart of illustrative steps involved in providing tests and other types of interactive games in accordance with one embodiment of the present invention;

FIG. 11 is a flow chart of illustrative steps involved in targeting advertisements to a user based on trends observed in a cluster in accordance with one embodiment of the present invention;

FIG. 12 is an illustrative athlete biography screen in accordance with one embodiment of the present invention;

FIG. 13 is an illustrative athlete biography screen including additional information for a user-selected advertisement in accordance with one embodiment of the present invention;

FIG. 14 is a flow chart of illustrative steps involved in providing advertisements associated with a contest element in accordance with one embodiment of the present invention;

FIG. 15 is a flow chart of illustrative steps involved in a user selecting an advertisement in accordance with one embodiment of the present invention;

FIG. 16 are illustrative database records in accordance with one embodiment of the present invention;

FIG. 17 is a flow chart of illustrative steps involved in matching advertisements to contest screens in accordance with one embodiment of the present invention; and

FIG. 18 is a flow chart of illustrative steps involved in matching advertisements to users in accordance with one embodiment of the present invention.

### DETAILED DESCRIPTION OF THE INVENTION

The fantasy sports contests of the present invention may include any suitable sports contest in which the user is given the ability to make decisions that may affect the standing of the user in the sports contest. For example, in typical team-oriented fantasy sports contests, the user may participate in the capacity of a general manager. In this situation, the user may have responsibilities such as creating a team roster (e.g., drafting players), selecting player positions, selecting starters, selecting relievers, making trades, and otherwise maintaining the composition of the user's team roster. It will be understood that any other suitable decision-making capability may be given to the user in a fantasy sports contest in addition to or in place of those indicated above.

The fantasy sports contest of the present invention need not be limited or restricted in time. For example, a fantasy sports contest may last an entire season, a portion of the season, a definite period of time (e.g., one month, two weeks, three days, one hour, etc.), the duration of a particular event (e.g., Wimbledon, etc.), a portion of a particular event, or any other suitable period of time.

In one suitable approach, fantasy sports contests may include contests in which the user is not necessarily playing the role of a general manager. For example, fantasy sports contests may involve the user determining or guessing (i.e., blindly or with calculation) whether particular outcomes will occur (e.g., whether a particular golfer will make the next putt). Any such suitable decision-making may be the basis of a fantasy sports contest or a part of a fantasy sports contest.

The fantasy sports contests of the present invention may use any suitable one or more scoring systems. For example, existing fantasy scoring systems include straight point systems (e.g., points are awarded and subtracted based on real-life plays without regard to the performance of other players on other fantasy teams in a league), rotisserie systems (e.g., points are awarded based on the user's relative ranking against other users), head-to-head systems (e.g., users in a league are matched against one another in a round-robin series of one-on-one contests during the course of a season). These are merely illustrative scoring systems. Any other suitable scoring system may be used in the fantasy sports contests of the present invention.

It will be understood that the above are merely illustrative elements of fantasy sports contests. Any other suitable arrangement or approach may be used. It will further be understood that the nature of the fantasy sports contests may vary depending on which activity or sport is involved or based on any other suitable criteria.

The fantasy sports contest application of the present invention may provide to the user fantasy sports contest-related information. Fantasy sports contest-related information may include any suitable information associated with one or more fantasy sports contests in which the user participates or in which the user may have an interest. For example, fantasy sports contest-related information may include information regarding the user's one or more rosters, the user's standing in one or more fantasy sports contests, point tallies associated with the user in one or more fantasy sports contests, information regarding the number of trades that the user may make, information regarding the amount of fantasy money available to the user for contracting players for a roster, information regarding deadlines to make trades or to perform any other suitable task associated with one or more fantasy sports contests, or any other suitable information.

Fantasy sports contest-related information may also include information regarding real-life athletes (e.g., names, statistics, etc.), real-life sports leagues (e.g., game schedules, standings, etc.), real-life sporting events (e.g., baseball games, golf tournaments, tennis matches, etc.), sports arenas, weather information, sports commentary, or any other suitable information regarding real-life sports or events that may have an affect on the one or more fantasy sports contests in which the user participates.

The present invention is primarily described herein in terms of the fantasy sports contest application. It will be understood that any other suitable software, hardware, or both may be used in conjunction with the fantasy sports contest application to implement some or all of the present invention.

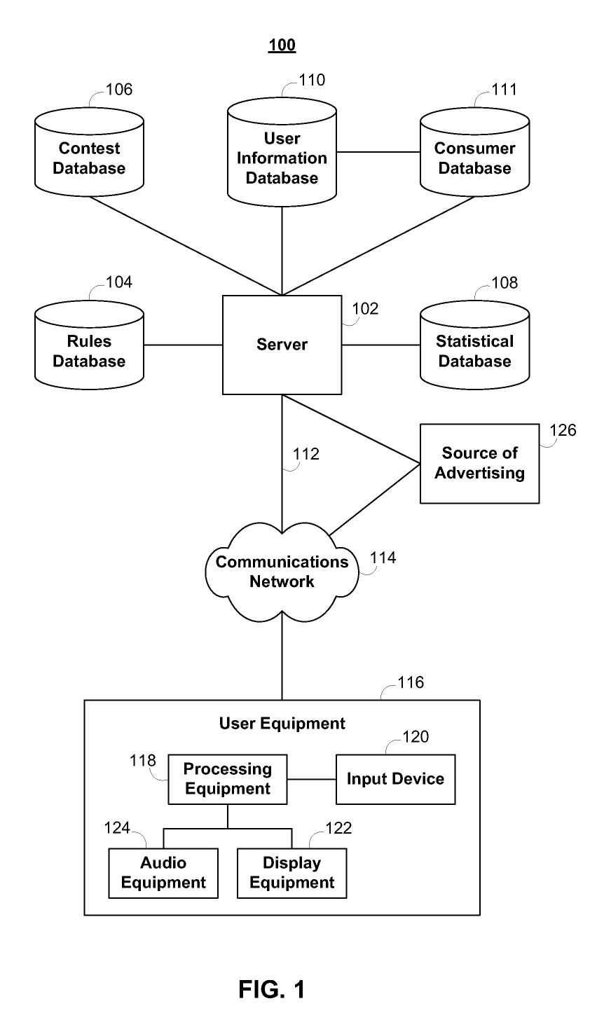

FIG. 1 shows an illustrative client/server system 100 in accordance with one embodiment of the present invention. A fantasy sports contest application or contest system application may be entirely or partially implemented on one or more servers 102. Server 102 may access one or more databases having information related to the fantasy sports contest such as, for example, rules database 104, contest database 106, statistical database 108, user information database 110, external databases such as consumer database 111, or any other suitable database.

Rules database 104 may be used to store rules for one or more fantasy sports contests. Statistical database 108 may include real-time real-life statistical information on athletes in one or more real-life sports categories (e.g., baseball, basketball, football, etc.). Contest database 106 may include any other types of data used in conjunction with the operation of one or more particular fantasy sports contest application or contest system (e.g., game time, game duration, etc.).

User information database 110 may be used to store user profiles having user-specific information, such as demographic information (e.g., age, sex, address, marital status, etc.), psychographic information (e.g., personality, habits, etc.), behavioral information (e.g., purchase history, internet activities, etc.), systems information (e.g., operating system, browser, connection, etc.), any other suitable information specific to the user, or any combination thereof. User-specific information may be provided by the user, (e.g., during registration), extracted from external databases (e.g., consumer database 111), collected as clickstream data (e.g., from cookies installed on the user's browser, from log files recording user interactions with the fantasy sports contest application, etc.), using any other suitable approach, or any combination thereof.

Consumer database 111 may be any suitable external database having consumer information that may be matched to user profiles stored in user information database 110. For example, consumer database 111 may be commercial databases maintained by companies like Donnelley Marketing (having a place of business at Greenwich, Conn.), which include consumer purchase information like that which might be collected from various sources such as catalog retailers.

The user's social security number, drivers license number, any other suitable identification, or any combination thereof may be used as search parameters for identifying data available about the user from various sources. Such key identification information may be obtained through various methods. For example, when signing up for multi-channel television service, a system operator may request identity information from the user or may compile it when the installer visits. This information may include, for example, the user's social security number, driver's license number, number of television sets, video recorders, disc players, and any other information identifying the user, or any combination thereof. This information may be obtained and stored in database 110. When a user search is to be performed in consumer database 111, such identification information may be used as the search parameter in consumer database 111.

In some arrangements of system 100, user information database 110 may directly extract data from consumer database 111. Alternatively, server 102 may extract useful data from consumer database 111 and then transfer the data for storage in user information database 110. For example, searches may be triggered by stored procedures in user information database 110 to extract information associated with a user based on, for example, algorithms constructed to identify certain users. As another example, the fantasy sports contest application may perform searches periodically (e.g., once per day, once per week, etc.), continuously, on-demand (e.g., when a new user profile is created), or at any other suitable interval. As another example, server 102, upon receiving user registration information, may search consumer database 111 for additional information matching the new user with marketers desirous of communicating with the user. Server 102 may subsequently integrate registration information and additional information from consumer database 111 into the user profile for storage in user information database 110.

The user information database 110 may also include other user-related information such as a history of Internet sites visited by the user. If it is detected that a user has visited specific sites (e.g., automobile sites) recently, the fantasy sports contest application may initiate additional analysis on the user. The analysis may include searches in customer database 111 to obtain, for example, the user's credit report, area income levels for the user's address, any other useful information, or any combination thereof for which selection criteria has been established. If the fantasy sports contest application determines, for example, based on this information, that the user has an ability to finance a new car purchase, has a two-seater vehicle, has just had a new baby, the fantasy sports contest application may obtain and show suitable advertisements for sports utility vehicles, vans or other automobiles that are most compatible with the user's profile from source of advertising 126.

Communication network 114 may be used for communication between users having user equipment 116 and server 102. Multiple communication network 114 and multiple user equipment 116 may be desired, although only one of each is shown to avoid over-complicating the drawing. User equipment 116 may include processing equipment 118 for receiving and transmitting fantasy sports contest-related data. The user may interact with processing equipment 118 using input device 120 such as, a remote control, a keyboard, a voice-recognition device, a track ball, a mouse, a cell phone, a personal digital assistant (PDAs), any other suitable device, or any combination thereof.

Fantasy sports contest-related data and video received by processing equipment 118 may be displayed for the user on display equipment 122. Display equipment 122 may be, for example, a television, a monitor, or any other suitable display equipment. Audio information may be played for the user using audio equipment 124 (e.g., speakers). Audio equipment 124 may be stand-alone equipment or integrated with display equipment 122.

In some embodiments of the present invention, the fantasy sports contest application may obtain advertisements for displaying on user equipment 116 from source of advertising 126. In one suitable approach, advertisements from source of adverting 126 may be directly communicated to user equipment 116 over communication network 114. In another approach, advertisements may be first communicated to server 102 and then communicated to user equipment 116 along with other fantasy sports contest information. In some embodiments of the present invention, the fantasy sports contest application may email advertisements obtained from source of advertising 126 to the user.

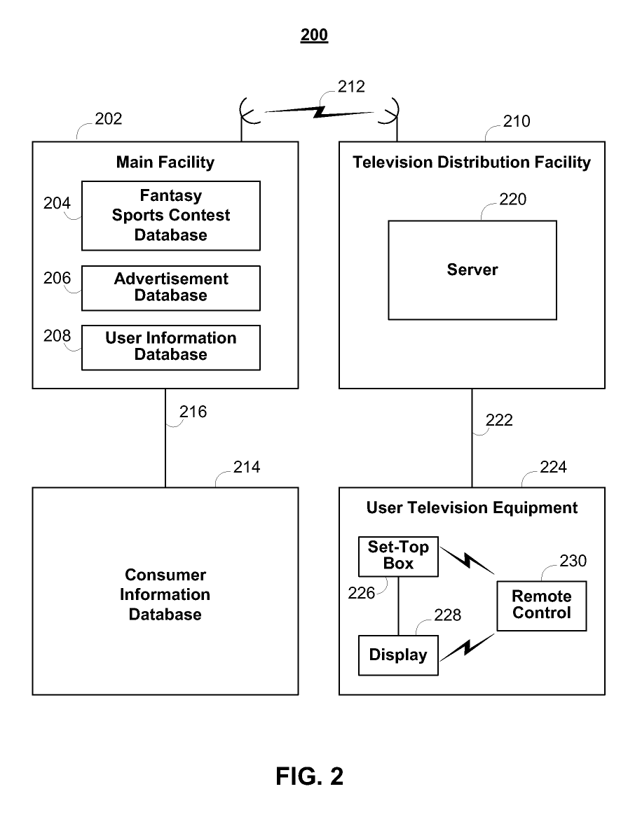

In one embodiment of the present invention, the fantasy sports contest application may be implemented on an interactive television platform. FIG. 2 shows such an illustrative fantasy sports contest system 200. Main facility 202 may include fantasy sports contest database 204, advertisement database 206, and user information database 208. Fantasy sports database 204 may include contest-related information, such as, for example, contest schedule, draft roster, contest rules, or any other suitable contest-related information. Advertisement database 206 may store advertisement related information, such as, for example, advertising banners, routing destination, target audience, or any other suitable advertisement information.

User information database 208 may include user profiles, in which user-specific information may be stored. User-specific information may be, for example, demographic information (e.g., age, sex, address, marital status, etc.), psychographic information (e.g., personality, habits, etc.), behavioral information (e.g., purchase history, internet activities, etc.), systems information (e.g., operating system, browser, connection, etc.), any other suitable information specific to the user, or any combination thereof. User-specific information may be provided by the user, (e.g., during registration), extracted from external databases (e.g., consumer information database 214), collected as clickstream data (e.g., from cookies installed on user browser or from log files recording user interaction with contest system), or using any other suitable approach.

Data from main facility 202 may be communicated to television distribution facility 210 over communication path 212. Data files from main facility 202 may be, for example, encapsulated as objects communicated using a suitable Internet based addressing scheme and protocol stack (e.g., a stack using user datagram protocol (UDP) and Internet protocol (IP)).

Consumer information database 214 may be any suitable information source for providing consumer data to main facility 202 over communications path 216. Consumer information database 214 may be, for example, a marketing information database (e.g., for a marketing company), a retailer database (e.g., for a catalog retailer), a financial database (e.g., for a credit card company), or any other suitable storage of consumer information.

Communication paths 212 and 216 may be any suitable communication paths for communicating and distributing fantasy sports contest application data and contest data (e.g., contest related data, advertisement related data, user data, and any other data used in the fantasy sports contest application). Communication paths 212 and 216 may be, for example, satellite links, telephone links, land lines, cable or fiber optic links, microwave links, Internet links, a combination of such links, or any other suitable communication path. In some arrangements, video signals may be communicated over communications path 212. In these arrangements, a relatively high bandwidth link such as a satellite link may be preferable to a relatively low bandwidth link such as a telephone line for efficiency.

Television distribution facility 210 is any suitable facility for communicating television signals to users. Television distribution facility 210 may be, for example, a cable system headend, a broadcast distribution facility, a satellite television distribution facility, or any other suitable facility. Television distribution facility 210 may receive fantasy sports contest application and contest-related data (e.g., rosters, standings, statistical information, or any other suitable data) and advertisement data (e.g., text, graphics, and video for various products and services) from main facility 202. Television distribution facility 210 of some embodiments of the present invention may also receive such data from facilities other than main facility 202.

Regardless of the data source, fantasy sports contest application information, advertisement information, and user information may be maintained on server 220 within television distribution facility 210 if desired. In addition, user information specific to registered user and other identifiable users may be collected and maintained on server 220 (e.g., all or parts of a user profile). Server 220 may be capable of handling text, graphics, video, and providing interactive services such as, for example, handling product and service order, user tracking, or any other suitable interactive services. Server 220 may be based on one or more computers.

Television distribution facility 210 may provide fantasy sports contest application, other contest applications and their associated data, advertisement data, user data, and any other data used in conjunction with such systems and methods to user television equipment 224 or any other suitable user equipment over communication path 222. Data may be communicated by television distribution facility 210 using a variety of techniques. For example, text and graphics may be communicated over an out-of-band channel using an out-of-band modulator, while large quantity of video may be communicated using one or more digital channels for better efficiency. If desired, text and graphics may also be transmitted using digital channels.

Communications path 222 may be any communications path suitable for communicating fantasy sports contest application and contest information. Communications path 222 preferably have sufficient bandwidth to allow television distribution facility 210 to communicate scheduled television programming, pay programming, advertising and promotional videos, and other video information in addition to the fantasy sports contest application and related data to user television equipment 224. Communications path 222 may be, for example, a satellite link, a telephone network link, a cable or fiber optic link, a microwave link, an Internet link, a data-over-cable service interface specification (DOCSIS) link, a combination of such links, or any other suitable communications path. There are typically multiple pieces of user television equipment 224 and multiple associated communications path 222, although only one of each are shown in FIG. 2 to avoid over-complicating the drawing. If desired, fantasy sports contest information, advertisement information, and user information may be communicated by one or more distribution facilities that are similar to, but separate, from television distribution facility 210 using one or more communications paths that are separate from communications link 222 (e.g., using Internet links).

User television equipment 224 may include a receiver such as, for example, set-top box 226 or any other suitable television or computer equipment into which circuitry similar to set-top box circuitry has been integrated. For clarity, the present invention is described primarily in the context of user television equipment including a set-top box. However, it should be apparent to those skilled in the art that the fantasy sports contest application may be implemented using user television equipment 224 that is based on, for example, a personal computer, a WebTV box, a personal computer television (PC/TV), a handheld computing device, or any other suitable equipment. In some embodiments of the present invention, fantasy sports contest application may also be implemented using a client-server setup, where user television equipment 224 may be a client processor and one or more servers such as server 220 may act as the server processor.

Fantasy sports contest application related data, contest data, advertisement related data, and user data may be communicated to set-top box 226 periodically (e.g., once per hour, once per day, etc.), continuously, or on-demand. Data may also be communicated from set-top box 226 to television distribution facility 210 for processing. Such data may include, for example, requests for certain fantasy sports contest application-related data, requests for advertisement-related data, submitted user data (e.g., user registration data, user clickstream data, etc.), or any other suitable data. Television distribution facility 210 may process such data and take appropriate action, such as, for example, sending information requested back to set-top box 226, receiving and storing user data (e.g., on server 220), or performing any other suitable action.

If desired, certain functions such as a user's instructions to make a change in his roster or transmission of clickstream data may be communicated by set-top box 226 over separate communications paths to facilities separate from television distribution facility 210 for processing. Such facilities may be, for example, main facility 202 or any other suitable facility. In these embodiments, some of the communication involving set-top box 226 may be made directly with the separate facilities.

Each set-top box 226 may include a processor to handle tasks associated with implementing a fantasy sports contest application on set-top box 226. Television distribution facility 210 may include a processor for tasks associated with monitoring a user's interactions with the fantasy sports contest application implemented on set-top box 226 and for handling tasks associated with the communication of information related to the fantasy sports contest application, associated advertisements, and other relevant data.

Fantasy sports contest application-related information received from television distribution facility 210 by set-top box 226 may be displayed for the user on display 228. One or more remote controls such as remote control 230 may be used to control set-top box 226 and display 228. Alternatively, user input devices such as, for example, wireless keyboards, mice, trackballs, or any other suitable input devices may be used to communicate with set-top box 226 and display 228 in place of remote control 230.

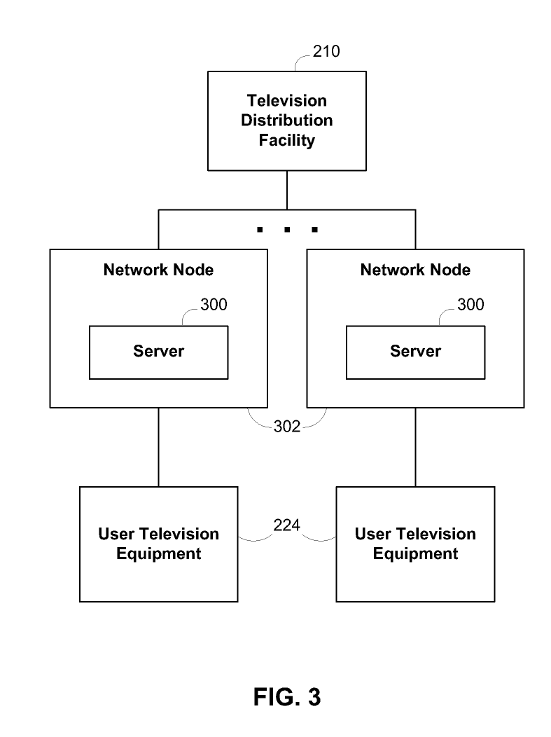

FIG. 3 shows an alternative arrangement for communicating data from television distribution facility 210. Server 220 (FIG. 2) residing at television distribution facility 210 may be replaced by or used in conjunction with servers 300 located at network nodes 302. Graphical information associated with advertisements may be downloaded periodically (e.g., once per hour, once per day, etc.) or continuously in a looping arrangement from servers 300 and stored locally. When a looping arrangement is implemented, a map may be provided periodically to indicate the location of the most recent graphical information. Fantasy sports contest application or other contest application implemented using set-top box 226 (FIG. 2) may access downloaded graphical information locally when needed and use the map to locate the most recent downloaded information on the digital channels.

Server 220 (FIG. 2) or servers 300 (FIG. 3) may be used separately or in conjunction to provide graphical information upon request in another suitable arrangement. If desired, server 220 or servers 300 may provide instructions to set-top box 226 (FIG. 2) informing the location of the graphical information on a particular digital channel. Text information for advertisements may be communicated to set-top box 226 along with fantasy sports contest application-related data. Text information may also be provided by server 220 (FIG. 2) using a continuously looping arrangement or on request similar to methods discussed above for graphical information. A cable modem may be used to communicate texts, graphics, and videos. Text information, graphical information, and videos for advertisements may be communicated using a combination of these techniques or any other suitable technique.

The fantasy sports contest application may be any suitable software, hardware, or both that may be used to implement the features of the present invention. The fantasy sports contest application may be implemented at any suitable location in system 100 of FIG. 1. For example, the fantasy sports contest application may be implemented at user equipment 116, at server 102, at any other suitable location (that is not necessarily shown in system 100), or at any combination thereof.

The fantasy sports contest application may also be implemented at any suitable location in system 200 of FIG. 2. For example, the fantasy sports contest application may be implemented at television distribution facility 210, at main facility 202, at any other suitable location (that is not necessarily shown in system 200), or at any combination thereof. For example, in system 200 of FIG. 2, certain portions of the fantasy sports contest application may be implemented at user equipment 224, (e.g., those portions that implement features involved in user interaction), whereas certain other portions of the fantasy sports contest application may be implemented at television distribution facility 210 (e.g., those portions that implement features involved in the processing of client requests and in the tracking of the performance of users). Any such suitable arrangement of the fantasy sports contest application may be implemented in accordance with the present invention.

Aspects of the operation of fantasy sports contest applications are described in U.S. Pat. No. 4,918,603 (Hughes, et al.), U.S. Pat. No. 5,846,132 (Junkin), U.S. Pat. No. 5,971,854 (Junkin), and U.S. Pat. No. 6,193,610 (Junkin), which are all hereby incorporated by reference herein in their entireties.

Data mining and other marketing techniques may be integrated into a fantasy sports contest application to provide customized advertisements or other marketing-related communications or content to the user. Data mining and other marketing techniques may include, for example, creating and analyzing user profiles. A user profile may be a collection of information specific to a user including, for example, demographic information (e.g., age, sex, address, marital status, etc.), psychographic information (e.g., personality, habits, etc.), behavioral information (e.g., purchase history, internet activities, etc.), systems information (e.g., operating system, browser, connection, etc.), any other information that may be useful for customizing advertisements or other marketing related content for the user, and any combination thereof.

The fantasy sports contest application may collect user information stored in a user profile from, for example, a user registration form, external consumer information database (e.g., consumer information database 218 (FIG. 2), consumer database 111 (FIG. 1), any other suitable external commercial database, or any combination thereof), Internet log files (e.g., on contest servers 102 (PIG. 1), server 220 (FIG. 2), servers 300 (FIG. 3), any other suitable server, or any combination thereof), cookies stored on user browsers, any other suitable information storage locations both online and offline, or any combination thereof.

In some embodiments of the present invention, the fantasy sports contest application may automatically search external consumer information databases for additional user information, while in other embodiments, the fantasy sports contest application may only perform such searches with explicit user consent due to privacy restrictions. In these embodiments, the fantasy sports contest application may offer special incentives (e.g., coupons, free services, products, etc.), for example, during the registration process, via email, via snail mail, during user interaction with certain fantasy sports contest information, or using any other suitable approach, to encourage users to give any required consent.

User profiles resulted from the series of information collection processes described above include extensive amounts of user information that may allow various marketing analysis to be performed by the fantasy sports contest application. In one suitable approach, the fantasy sports contest application may segment the users into unique clusters in which users exhibit similar characteristics. These characteristics may be, for example, demographics, psychographics, behaviors, systems, any other suitable characteristic, or any combination thereof. Such segmentation may attract, for example, various marketers who are interested in targeting specific groups of users because of these characteristics exhibit a higher propensity to purchase specific goods and services.

In some embodiment of the present invention, the fantasy sports contest application may associate the user's profile with one or more user clusters. The fantasy sports contest application may create explicit association between the user's profile and a cluster by, for example, storing an id of the user's user profile in a representative profile created to represent the particular user cluster.

Portions of the process involved in obtaining information associated with the user are illustrated in the following figures.

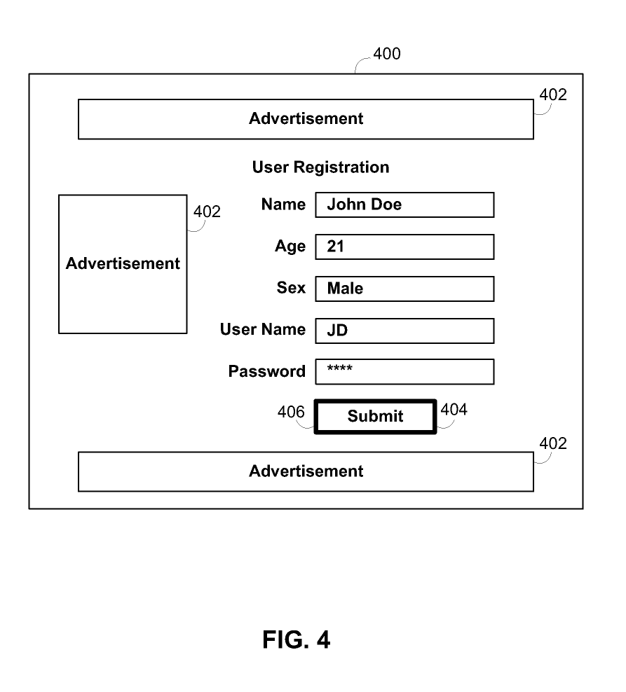

FIG. 4 shows an illustrative fantasy sports contest application registration screen 400 in accordance with one embodiment of the present invention. Registration screen 400 may include a registration form, a submit button 404 for submitting the registration form, and multiple selectable advertisements 402. A user may interact with screen 400 by, for example, positioning highlight region 406 over a selectable item on the screen, pressing suitable buttons (e.g., up and down buttons, various letter and number buttons, etc.) on a remote control, or using any other suitable approach. In this example, the user has completed the registration form and has positioned highlight region 406 on submit button 404.

Registration screen 400 is merely illustrative of such a display screen. Various other suitable arrangements may be used in its place. For example, in another arrangement, advertisement 402 may be displayed in a panel, as a banner, in an overlay, or in any other suitable arrangement.

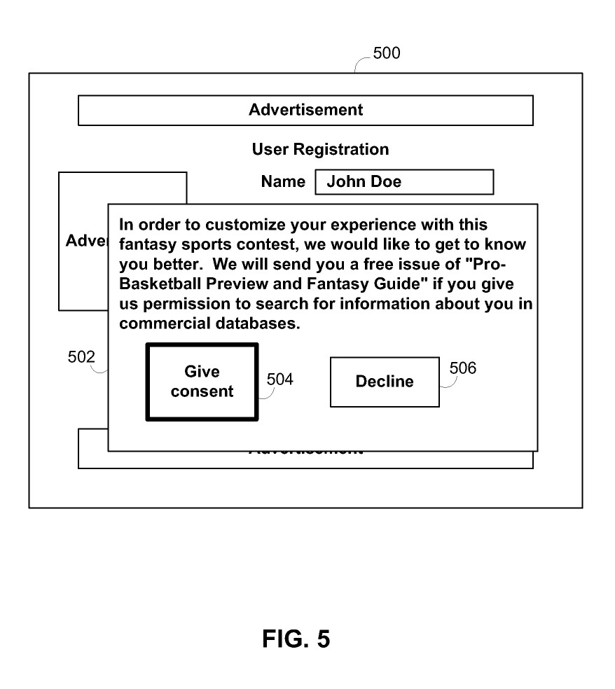

In embodiments in which searches for or interactions with additional user information in external databases may only be permitted with explicit consent, the fantasy sports contest application may present a pop up screen 502, as shown in FIG. 5, to the user in response to user-selecting submit button 404 on screen 400.

Pop up screen 502 may include a statement explaining the reason for the request, one or more special offers to encourage the user to give requested consent, and buttons or other mechanisms for the user to give or decline consent.

The fantasy sports contest application may offer the same special offers to all registering user or the fantasy sports contest application may customize the offers to the user based on, for example, the type of sport selected by the user, demographic information supplied by the user during registration, or any other suitable user-specific information. In this example, pop up screen b02 includes a message explaining to the user the reasons for the consent and offers the user a free issue of “Pro-Basketball Preview and Fantasy Guide” as an incentive. A button 504 is provided for the user to indicate consent, while another button 506 is provided for the user to decline,

Pop up screen 502 is merely illustrative of such a display screen. Various other suitable arrangements may be used in its place.

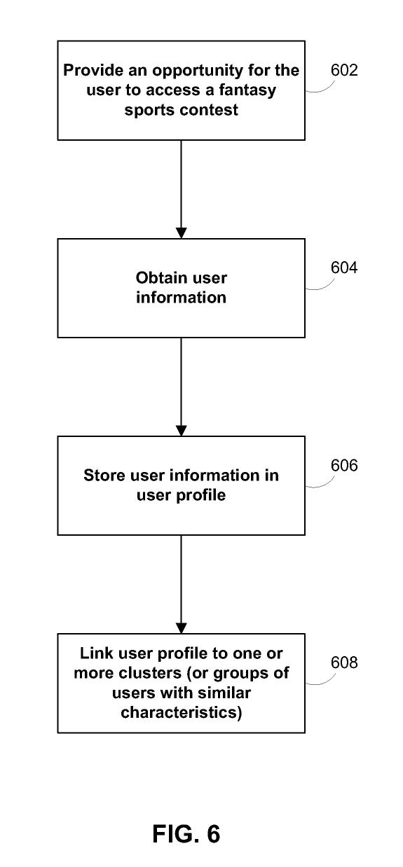

FIG. 6 is a flow chart of illustrative steps involved in creating a user profile in accordance with one embodiment of the present invention. At step 602, the fantasy sports contest application provides the user with an opportunity to access a fantasy sports contest by, for example, allowing the user to register as a fantasy sports user. As an example, the fantasy sports contest application may allow a user to enter registration information (e.g., name, sex, address, etc.) into, for example, a25532257_{—}1 registration form such as the form shown in FIG. 4.

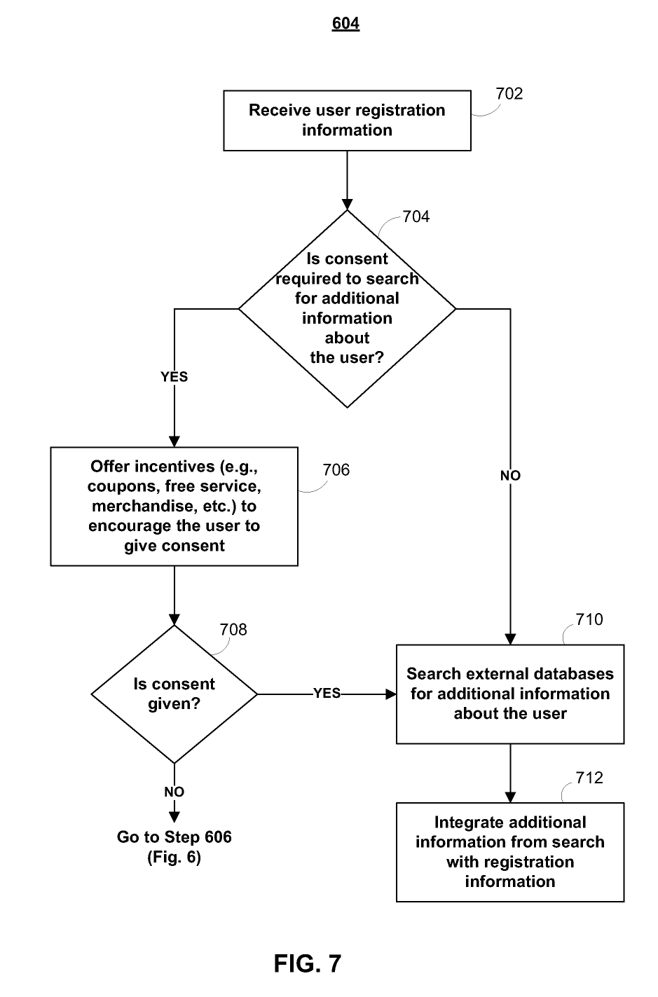

At step 604, the fantasy sports contest application receives user registration information. A more detailed description of this step will be given in the discussion of FIG. 7.

The fantasy sports contest application may store user information (e.g., user registration information and additional information) in a user profile to be located in, for example, user information database 110 (FIG. 1), user information database 208 (FIG. 2), or any other suitable database at step 606.

At step 608, the fantasy sports contest application may associate the user profile with one or more user clusters.

A user cluster may be a group of users having similar characteristics appropriate for a marketer. These characteristics may be, for example, demographics, psychographics, behaviors, systems information, any other suitable characteristic, or combination thereof. The fantasy sports contest application may associate individual user profiles to specific clusters by, for example, storing an identification associated with each user profile in a representative profile created to represent a user cluster.

As an example, in a cluster for sports fanatics, the fantasy sports contest application may identify a user profile that embodies the most number of identifiable characteristics of the cluster to be the representative profile. These characteristics may be, for example, has extensive knowledge of one or more sports, owns a collection of sports memorabilia, watches a large number of sporting events, or any other suitable characteristic. The fantasy sports contest application may allow an advertiser who is interested in the formation of a particular cluster to specify the characteristics.

Upon identifying the representative profile, the fantasy sports contest application may then associate other user profiles, which may include a portion of the characteristics embodied in the representative file, to the representative file to form the cluster.

The advertiser, who requested formation of the cluster, may be charged, for example, a flat fee for the formation of the cluster, a variable fee based on the number of characteristics used to form the cluster, a variable fee based on the number of user profiles in the cluster, or using any other suitable approach.

FIG. 7 shows a more detailed flow chart of illustrative steps involved in receiving user registration information in accordance with one embodiment of the present invention.

At step 702, the fantasy sports contest application receives user registration, for example, as datastream formatted as a web page that the fantasy sports contest application may download based on an embedded universal resource locator (URL), or as data in any other suitable form.

At step 704, the fantasy sports contest application determines whether explicit consent must be obtained from the user in order to conduct searches for or interact with additional information in external databases.

Requirements for user consent may vary by geographical locations, types of searches, nationalities, etc. As an example, explicit consent may be necessary for searches that may reveal a user's financial information, such as, for example, credit history, purchase history, or any other personal financial information. As another example, more strict consent requirements may apply to personal information searches in some countries, while less strict requirements may apply to similar searches elsewhere.

To account for these differences, the fantasy sports contest application may pre-determine and store consent requirements according to various criteria (e.g., geographical location, search type, or any other suitable categories) in suitable databases such as, for example, user information database 110 (FIG. 1), user information database 208 (FIG. 2), or any other suitable database. Requests for updated requirement may be sent to a server from user equipment.

If the fantasy sports contest application determines that explicit consent is necessary at step 704, the fantasy sports contest application may display a screen to the user which may include a consent request statement, incentives (e.g., coupons, free products, services, and mechanisms with which to give or refuse consent (step 706). The screen may be, for example, a pop up screen (e.g., screen 502), a banner, an overlay, a new fantasy sports contest screen, or any other suitable screen. The consent request statement may vary based on the various consent requirements that may be determined by the fantasy sports contest application at step 704 (e.g., geographical location, search type, etc).

If the user chooses not to give consent to offline searches for or interaction with additional user information in external databases (step 708), the fantasy sports contest application may proceed to step 606 of FIG. 6. In the case that consent is given by the user (step 708), or in the case that consent is determined by the fantasy sports contest application to be unnecessary at step 704, the fantasy sports contest application may search one or more external databases (e.g., consumer information database 218 (FIG. 2), consumer databases (FIG. 111), or any other suitable external databases) for additional information associated with the user at step 710.

Additional information may include demographic and behavioral information such as, for example, address, age, sex, marital status, past purchase information, credit history, mortgage information, or any other suitable information. Additional information may also include psychographic information inferred or gathered about the user based on user demographic and behavioral information or gather from tests administered to the user. For example, a user living in a high-income neighborhood with a purchase history showing purchases of multiple luxury cars of the latest model may be classified psychographically as a follower of expensive trends, or more specifically, a follower of expensive car trends. Additional information may further include systems information, which may reveal, for example, the operating system, browser, domain, modem speed, or any other suitable technical statistics associated with the user equipment with which the user communicates with the fantasy sports competition system.

The fantasy sports contest application may perform searches for additional user information at various locations depending on the chosen implementation. For example, user registration information may be transmitted from user television equipment 224 (FIG. 2) to a centralized location (e.g., main facility 202 (FIG. 2), television distribution facility 210 (FIG. 2), or any other suitable location), in which the fantasy sports contest application may perform searches offline periodically (e.g., once a day, once a week, etc.) to add additional information to stored registration information (step 712).

While the fantasy sports contest application is integrating additional information with registration information at step 712, the fantasy sports contest application may replace some untrusted registration information with information obtained from trusted external databases. In a subscription cable system, the fantasy sports contest application may also obtain various information that operators or service providers have stored concerning their customers.

In addition to obtaining descriptive user information, the fantasy sports contest application may also obtain user behavior information through various channels.

In one suitable approach, the fantasy sports contest application may communicate cookies along with fantasy sports contest information to user equipment. The cookie may include mechanism for recording the user's interaction with various applications (e.g., Internet sites). In some embodiments of the present invention, the cookie may only record user interaction with applications of interest in order to reduce the amount of data generated. In these embodiments, the fantasy sports contest application may allow, for example, an advertiser, to specify the type of user interactions to record. The cookie may periodically communicate the recorded information to the fantasy sports contest application. The fantasy sports contest application may subsequent integrate the information into the user's user profile. Alternatively, the fantasy sports contest application may provide the information directly to the advertiser.

For example, a car dealer may want to know the car models that the user is interested in. The car dealer may request for the fantasy sports contest application to monitor the user's interactions with a number of Internet sites that include information on various car models. The fantasy sports contest application may provide a cookie including mechanism to record the user's interactions with these Internet sites to the user equipment. Information recorded may be periodically communicated from the cookie to the fantasy sports contest application.

In another suitable approach, the fantasy sports contest application may record the user's interaction with the various screens of the fantasy sports contest application (e.g., clickstream data). Such data may be stored in the user profile and analyzed by the fantasy sport contest application at a later time to infer, for example, user behavior information.

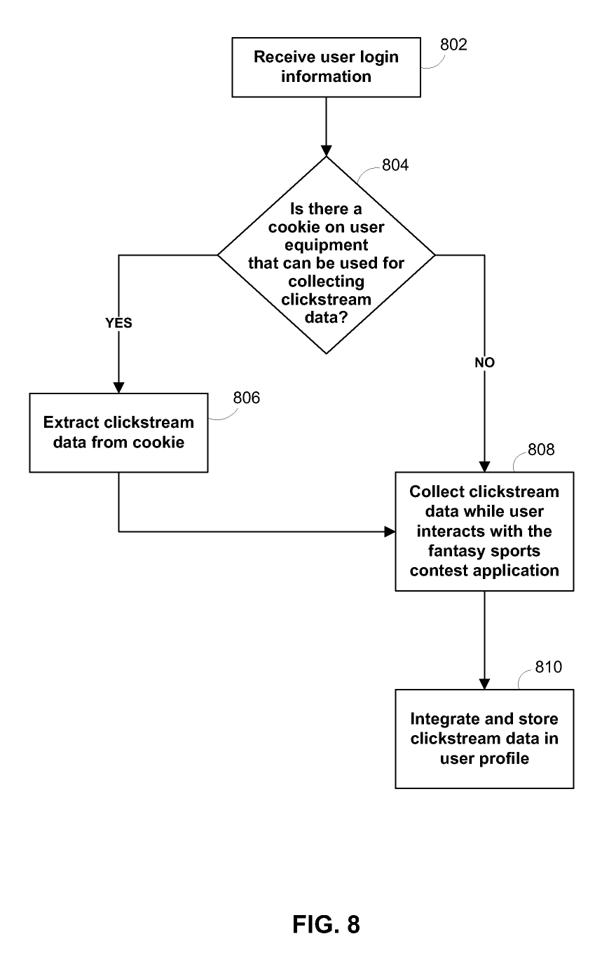

FIG. 8 shows a flow chart of illustrative steps involved in integrating clickstream data into the user profile. At step 802, the fantasy sports contest application receives user login information. The fantasy sports contest application may receive user login information from, for example, a fantasy sports contest screen with a login form, a cookie installed on user equipment, which includes user login information, a URL stream from an Internet location having a common login with the fantasy sports contest application, an Internet log-on screen, a conditional access security device, or any other suitable location.

When the fantasy sports contest application determines the user's identity, the fantasy sports contest application checks the user browser for cookies (or similar mechanisms) installed to collect clickstream data (e.g., pages viewed, files downloaded, products and services purchased, etc.) at step 804. Clickstream data is data generated by the user when interacting with Internet-delivered contest (e.g., web pages). If the fantasy sports contest application detects no cookies (or similar mechanisms), the fantasy sports contest application proceeds to step 808. If the fantasy sports contest application is able to detect a cookie, the fantasy sports contest application extracts and removes clickstream data from the cookie (or similar mechanisms) at step 806 and then proceeds to step 808.

At step 808, the fantasy sports contest application collects clickstream data (e.g., pages viewed, files downloaded, products and services purchased, etc.) while the user interacts with fantasy sports contest screens.

The fantasy sports contest application integrates and stores both clickstream data extracted from cookies (step 806) and clickstream data collected during the user's interaction into stored user profile at step 810.

The fantasy sports contest application may also employ various recreational methods to obtain additional information about the user. The additional information may be information that is hard to obtain through more direct channels described above. The fantasy sports contest application may analyze such information to record the user's life-style characteristics such as, price conscious, homebody, dieter, information seeker, or any other suitable characteristic. The fantasy sports contest application may then use these life-style characteristics to target advertisements and other market-related content to the user.

In some embodiments of the present invention, the fantasy sports contest application may provide tests such as personality tests and other types of interactive games to collect user information. The tests and games may be specifically designed to gather certain types of information about the user or may be more general tests and games designed to gather a wide range of information about the user for further analysis. This information may confirm the validity of existing information in user profiles or add new information that may have been difficult to obtain using other methods. For example, user personality information (e.g., extraverted, introverted, impulsive, etc.) are not directly provided by users, and may take extensive analysis to infer from collected information at a low level of accuracy.

The fantasy sports contest application may provide customized personality test and other types of games to capture various types of desired information about the user. For example, the fantasy sports contest application may provide one or more tests, in which the user supplies demographic information such as, for example, age, sex, geographical location, or any other suitable personal information. Because the user may provide accurate demographic information in the process of a personality test in exchange for more accurate results, the fantasy sports contest application may use this information to confirm or correct information in the user profiles.

As another example, the fantasy sports contest application may provide predictive tests or games that are designed to help predict psychographic or behavioral information about the user. In these tests, users may supply various personal information into a model, through which a prediction may be determined to both satisfy the user's curiosity and provide valuable user information for the user profile (e.g., a test to determine an automobile suitable to the personality of the user).

For example, based on a combination of the user's answers to a survey about eating habits and other stored user information (e.g., sex, age, geographical location, purchase behavior, etc.), the fantasy sports contest application may predict that the user is a dieter. The fantasy sports contest application may display this prediction to the user. At the same time, the fantasy sports contest application may insert information inferred from this prediction into the user profile. Information inferred from such a prediction may be, for example, the user may be more socially active, the user may have a tendency to try new products, or any other suitable information that may be inferred.

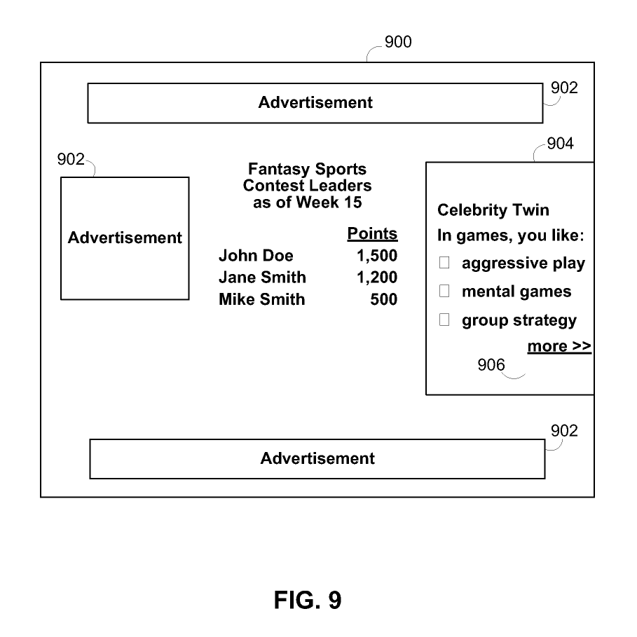

FIG. 9 shows an illustrative fantasy sports contest screen 900 including an interactive personality test 904 in accordance with one embodiment of the present invention. Screen 900 may be a display of any fantasy sports contest screen. Screen 900 may include, for example, contest information (e.g., sports league information, team statistics information, athlete-related information, or any other suitable sports contest information), one or more advertisements 902, and an interactive personality test or any other type of suitable interactive predictive game.

In this example, screen 900 includes a leaderboard, three advertisement banners 902, and a personality test 904. Personality test 904 is intended to predict a celebrity having similar personality as the user based on the user's answers to a series of personality-related questions.

The fantasy sports contest application may not be able to present all the questions of a given personality test on screen 900 due to space limitation. The fantasy sports contest application may present a portion of the questions on screen 900, while providing a link to route the user to another contest screen dedicated to displaying personality test information. In this example, one of the questions of the personality test is shown in section 904. A link “more >>” 906 is provided to route the user to an alternative contest screen.

Fantasy sports contest screen 900 is merely illustrative of such a display screen. Any other suitable display arrangement may be implemented in its place.

Other aspects of user profiling and targeted content delivery are described, for example, in Hosea et al. International Publication Number WO 01/20481 A2, filed Sep. 6, 2000, which is hereby incorporated by reference herein in its entirety.

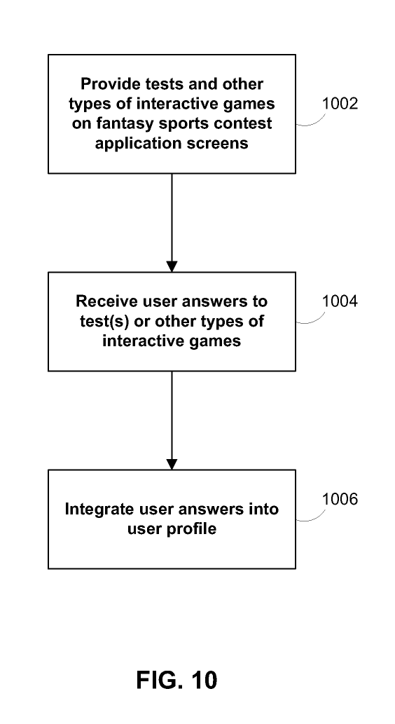

FIG. 10 shows a flow chart of illustrative step involved in integrating personality test data with user profiles in accordance with one embodiment of the present invention.

At step 1002, the fantasy sports contest application provides tests such as personality tests and other types of interactive games to the user on various fantasy sports contest screens. The fantasy sports contest application may receive user submission of personality test or game related information at step 1004 and may integrate the information into the user profile at step 1006.

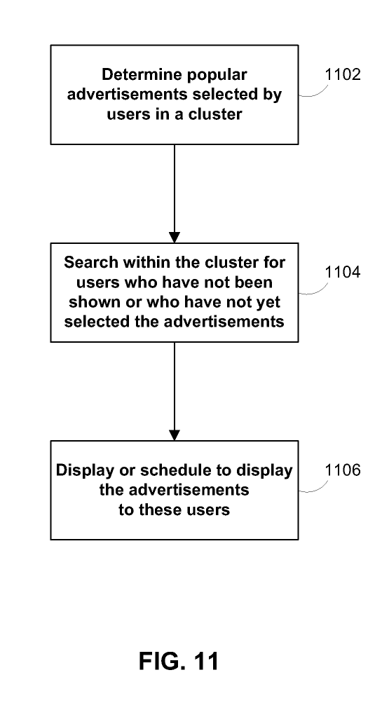

In some embodiments of the present invention, the fantasy sports contest application may target advertisements and recommend products and services to the user based on trends observed in a user cluster. FIG. 11 shows a flow chart of illustrative steps involved this type of personalization in accordance with one embodiment of the present invention.

At step 1102, the fantasy sports contest application determines advertisements, products, services, or any other suitable marketing content that have aroused significant interest among users of a certain cluster within a certain period (e.g., within a day, within the last week, within the last month, etc.). The fantasy sports contest application may determine such popular advertisements by, for example, comparing and analyzing the advertisements viewed by users within the cluster. The fantasy sports contest application may classify advertisements that received a significant amount of attention such as, for example, clicks, selection, view time, or any other signs of interest, as popular advertisements.

Because advertisements are shown at various times, locations, and are targeted at various groups of users, not all users within the same user cluster have seen the same advertisements. At step 1104, the fantasy sports contest application may search within the user cluster for users who have not yet been exposed to the popular advertisements (e.g., a popular advertisement may be one in which there is a high click-through rate).

The fantasy sports contest application may then show the popular advertisements to these users at step 1106. The fantasy sports contest application may also display the popular advertisements on more frequently visited contest screens as well as those displaying advertising related to subjects similar to one's already deemed popular within the user cluster. In some embodiments of the present invention, the fantasy sports contest application may deliver these popular advertisements and additional advertisements to the users using, for example, fax, email, cell phone, or any other suitable communication device. Because advertisers may be charged for each click-through, the fantasy sports contest application may actively “push” through these advertisements with a lot of interest.

The fantasy sports contest application may perform steps 1102 and 1104 offline, online, or both. However, when speed is desired, the fantasy sports contest application may perform offline analysis for efficiency.

In some embodiments of the present invention, the fantasy sports contest application may associate advertisements to various pre-identified attributes of contest elements such as an athlete, a team, a location, a competition, or any other suitable contest element. The fantasy sports contest application may display these advertisements when information related to the contest element that is associated with the advertisements is shown.

For example, an athlete (e.g., Tiger Woods) may be a spokesperson of a particular product (e.g., Buick automobile). Accordingly, the fantasy sports contest application may associate advertisements for Buick automobiles to the athlete and display these advertisements whenever information associated with the athlete is displayed (e.g., contest screen displaying the athlete's biographical information, golf championship leaderboard including scores for the athlete, or any suitable display including information related to the athlete).

In some embodiments of the present invention, the fantasy sports contest application may provide linked advertisements or recommendations. In these embodiments, the fantasy sports contest application may identify related advertisements and group these advertisements together. A user selection of one of these advertisements may trigger the fantasy sports contest application to display related advertisements.

The fantasy sports contest application may group related advertisements periodically (e.g., once a day, once a week, etc.), or on-demand at various locations depending on the chosen implementation. For example, the fantasy sports contest application may identify and group related advertisements (e.g., assigned a common group id) at, for example, main facility 202 (FIG. 2), television distribution facility 210 (FIG. 2), user television equipment 224 (FIG. 2), or any other suitable location.

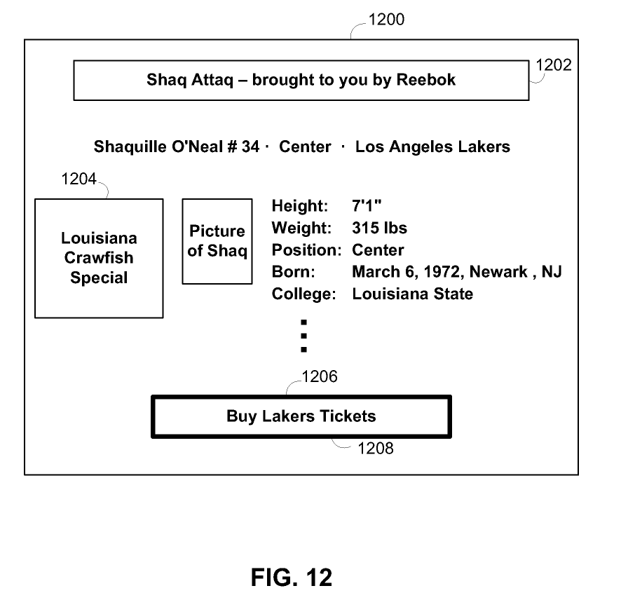

FIG. 12 shows an illustrative fantasy sports contest athlete biography screen 1200 in accordance with one embodiment of the present invention. Multiple selectable advertisements may be included on screen 1200. In this example, fantasy sports contest application screen 1200 displays biographical information for basketball player Shaquille O'Neal. Selectable advertisements 1202, 1204, 1206 display three advertisements associated with Shaquille O'Neal.

A user may select an advertisement on screen 1200. The fantasy sports contest application may provide additional information about the product or service being advertised or route the user to an alternative location (e.g., an Internet location) in response to a selection. The user may make a selection by, for example, positioning highlight region 1208 on an advertisement and pressing the “ok” button on a remote control, or using any other interactive communication device.

Fantasy sports contest athlete biography screen 1200 is merely illustrative of such a display screen. Any other suitable display arrangement may be used in its place.

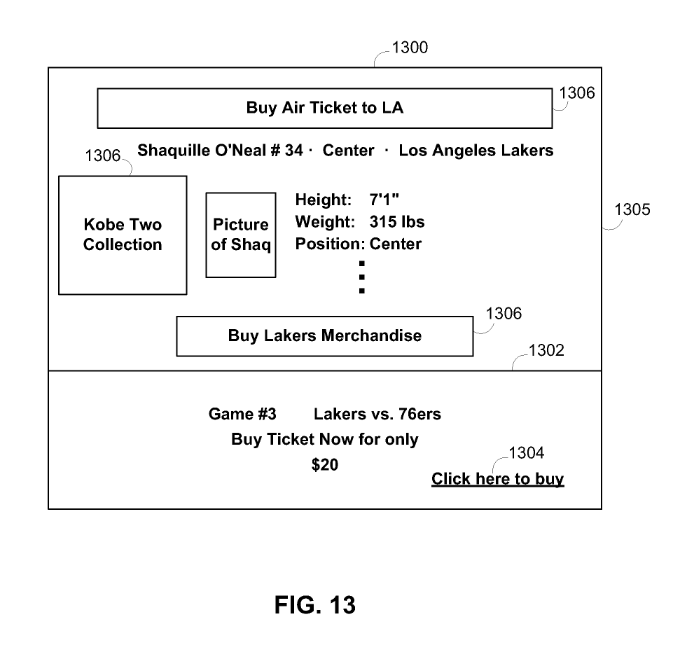

FIG. 13 shows an Illustrative fantasy sports contest screen 1300 in accordance with one embodiment of the present invention. The fantasy sports contest application may display screen 1300 in response to user selection of advertisement 1206 (FIG. 12). In contest screen 1300, additional information associated with the selected advertisement 1206 may be displayed in split screen 1302, which occupies the bottom half of screen 1300. The fantasy sports contest application may provide a link 1304 on split screen 1302 to encourage the user to purchase the advertised product or service. In this example, link 1304 allows the user to purchase tickets to game 3 of Lakers vs. 76ers.

The fantasy sports contest application may display biographical information shown on screen 1200 (FIG. 12) at a reduced size in the top split screen 1305. The fantasy sports contest application may also replace original advertisements 1202, 1204, and 1206 on screen 1200 (FIG. 12) with advertisements 1306, which is associated with the user-selected advertisement 1206 (FIG. 12).

Fantasy sports contest screen 1300 is merely illustrative of such a display screen. Any other suitable display arrangement and any other communication device may be used in its place.

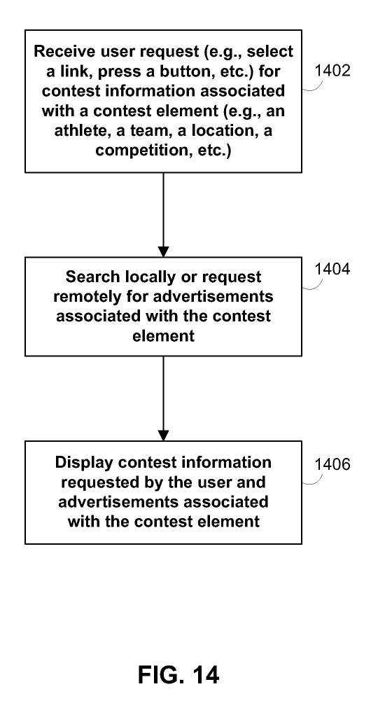

FIG. 14 shows a flow chart of illustrative steps involved in displaying advertisements associated with a contest element in accordance with one embodiment of the present invention. A contest element may be any suitable element that is a part of a fantasy sports contest. A contest element may be, for example, an athlete, a team, a location, a competition, or any other suitable element.

At step 1402, the fantasy sports contest application may receive user request to display contest information associated with a contest element (e.g., an athlete's biographical information). The user may make the request by, for example, selecting a link associated with the athlete's statistics, the athlete's biography, or any other information related to the athlete, pressing an “info” button on a remote control while highlighting an athlete's name or any other suitable information related to the athlete.

At step 1404, the fantasy sports contest application may perform a search for advertisements associated with the contest element involved in the user request for contest information. The fantasy sports contest application may perform the search at various locations depending on the chosen implementation. For example, the fantasy sports contest application may conduct the search locally at, for example, user television equipment 224 (FIG. 2), if advertisements are downloaded to user television equipment 224 periodically and stored in local memory. As another example, the fantasy sports contest application may conduct the search remotely at, for example, television distribution facility 210 (FIG. 2), if advertisements are communicated to user television equipment 224 (FIG. 2) upon request in a client-server arrangement. Advertisements may also be localized for one or more neighborhoods (e.g., a supermarket may wish to reach users in a particular geographic area). Geographic location techniques such as reverse appending of phone numbers might be used to obtain the home addresses of users. The localized advertisements may then be delivered to the users who have been determined to be located in the neighborhood that the advertiser wishes to target.

At step 1406, the fantasy sports contest application may display contest information requested by the user as well as advertisements associated with the contest element involved in the requested contest information. Such a display is shown in FIG. 12.

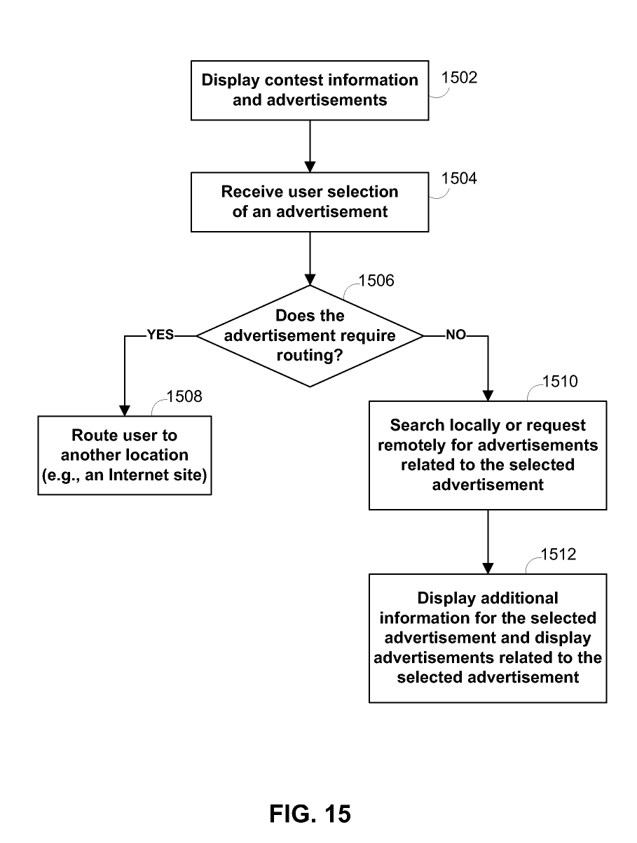

FIG. 15 shows a flow chart of illustrative steps involved in providing associated advertisements to the user in accordance with one embodiment of the present invention.

At step 1502, the fantasy sports contest application displays a fantasy sports contest screen (e.g., screen 1200), which includes contest information and one or more selectable advertisements, to the user. The fantasy sports contest application may receive user selection of one of the advertisements at step 1504. The user may select the advertisement by, for example, positioning highlight region 1208 (FIG. 12) on an advertisement and pressing a suitable button (e.g., “ok” button) on a remote control, clicking on the advertisement using a mouse, or using any other suitable approach.

The fantasy sports contest application may present information associated with advertisements to the user using various approaches. [n one suitable approach, when a user selects an advertisement, the fantasy sports contest application may display any additional information associated with the advertisement to the user. In another suitable approach, when a user selects an advertisement, the fantasy sports contest application may route the user to an alternative location (e.g., an Internet location) where a larger amount of information related to the advertisement may be presented to the user. The fantasy sports contest application may determine the type of approach to use with a particular type of advertisement at step 1506.

The fantasy sports contest application may determine the advertisement type through searches for routing information. These searches may be performed by the fantasy sports contest application at various locations depending on the chosen implementation. As an example, the fantasy sports contest application may search local memory on, for example, user television equipment 224, if advertisement information is downloaded periodically (e.g., once per day, once per week, etc.). As another example, the fantasy sports contest application may issue a search request to obtain routing information remotely (e.g., from television distribution facility 210 (FIG. 2) or any other suitable location) in a system where advertisement information is provided on demand.

At step 1508, the fantasy sports contest application may route the user to an alternative location (e.g., an Internet location) based on routing information gathered on the selected advertisement (step 1506). Alternatively, when no routing is required, the fantasy sports contest application may display additional advertisements or opportunities for the user to receive additional information associated with the selected advertisement at step 1510.

The additional information may be located through search performed by the fantasy sports contest application locally or requested by the fantasy sports contest application from remote sources. The fantasy sports contest application may display the additional information associated with the selected advertisement, for example, in the bottom half of the screen as shown in FIG. 13, in an overlay on top of screen 1200 (FIG. 12), or in any other suitable arrangement (step 1512).

The fantasy sports contest application may replace original advertisements (e.g., advertisements 1202, 1204, 1206 (FIG. 12)) with new advertisements associated with the selected advertisement (e.g., banners 1206), for example, in the top portion of screen 1300 as shown in FIG. 13.

In some embodiments of the present invention, the fantasy sports contest application may match advertisements to contest screens based on various pre-defined categories of characteristics. For example, the fantasy sports contest application may categorize an advertisement by, for example, intended audience, intended length of view, intended number of views, or any other suitable characteristics. Appropriate codes may be accorded to the advertisement by the fantasy sports contest application to represent each categorization.

Similarly, the fantasy sports contest application may categorize contest screens (e.g., login screen, team statistics screen, athlete-related screen, etc.) by, for example, average number of request per period (e.g., per day, per week, etc.), audience, average view duration per period, sequential relation to other contest screens (e.g., login screen typically lead to league overview), commonly associated user behavior (e.g., users supply login information on login screen), or any other suitable type of information. The fantasy sports contest application may accord appropriate codes corresponding to those associated with advertisements to contest screens. The fantasy sports contest application may then match advertisements for display on contest screens with matching category codes.

Categorization of both advertisements and contest screens may take place at various locations and at various times depending on the chosen implementation. For example, the fantasy sports contest application may perform such categorization offline periodically (e.g., once per day, once per week, etc.) at a centralized storage location such as main facility 202 (FIG. 2). As another example, the fantasy sports contest application may perform categorization at various distribution locations, such as television distribution facility 210 (FIG. 2), where categorization may be based on local or regional information. As yet another example, the fantasy sports contest application may perform categorization, on-demand, for example, when a new advertisement is added, when a contest screen is access by a user, or upon occurrence of any other suitable event.

The fantasy sports contest application may store advertisements, contest screens, and any other contest related item and their related categorization as records in suitable fantasy sports contest databases. These database may include, for example, contest database 106 (FIG. 1), sports contest database 202 (FIG. 2), or any other suitable database for storing such information.

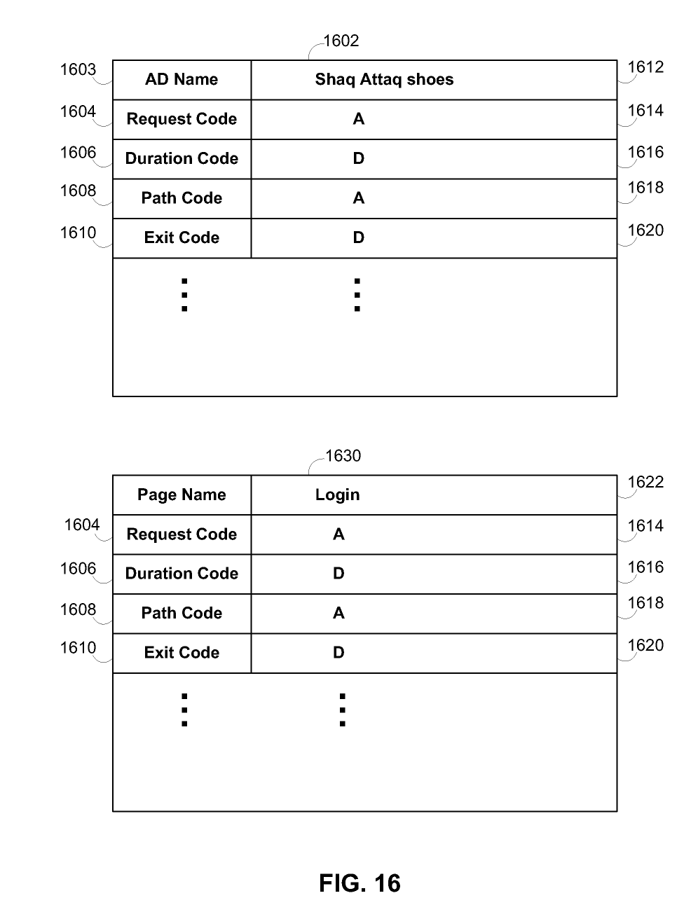

FIG. 16 shows two illustrative fantasy sports contest database records. Record 1602 is a record for an advertisement. Record 1630 is a record for a fantasy sports contest application screen. Advertisement record 1602 includes attribute categories 1603-1610 and corresponding attribute values 1612-1620. Value 1612 corresponds to attribute “ad name” 1603 and shows that the record is for an advertisement promoting Shaq Attaq sneakers. Attribute “request code” 1604 denotes the level of reach that is desired for the advertisement.

The fantasy sports contest application may pre-define reach levels based on various criteria such as, industry standards, average traffic on fantasy sports contest system, or any other suitable criteria. Reach levels may range, for example, from A to D, where A denotes the highest reach while D denotes the lowest.

In this example, the fantasy sports contest application has accorded advertisement “Shaq Attaq” an “A” value (attribute request code 1604), signifying the advertiser's desire for high reach for this advertisement.

Attribute duration code 1606 indicates the view duration desired for the advertisement. View duration is the amount time a typical user spends “viewing” the contest screen having the advertisement. A user viewing the contest screen having the advertisement may not necessary select the advertisement. However, longer view duration creates an extended opportunity to attract user attention and increases brand recognition.

For example, an advertisement including a large amount of text may require a longer view duration for a user to grasp the message. As another example, an animated advertisement displaying a series of images may require a longer view duration to complete the animation. In this example, the fantasy sports contest application has assigned advertisement “Shag Attaq” a very low (e.g., D) duration code 1606. This could mean that the “Shag Attaq” advertisement includes short animations or very little text for the user to comprehend.

Advertisement record 1602 may also include attribute path code 1608. The fantasy sports contest application may assign path code 1608 to indicate the desired reach on certain “paths” frequently taken by various users to access a sequence of contest screens. For example, users may often begin interaction with the fantasy sports contest application at the login screen. Upon login, users may be directed to a league overview screen displaying information for the league that the user competes in. Based on the fact that many users access these two screens in this sequence, the fantasy sports contest application may recognize the connection between the login screen and league overview screen as a “path”.

The fantasy sports contest application may systematically determine paths by analyzing user interaction information collected (e.g., clickstream data) during user visits. In some embodiments of the present invention, the fantasy sports contest application may further classify paths according to, for example, clusters, sports, or any other suitable category similar to the ones described so far. The fantasy sports contest application may assign a high value corresponding to path code 1608 such as in this example, to signify that an advertiser's desire to show the banner multiple times on the same path. Such an assignment may increase the frequency of view per user per visit for the particular advertisement.

Alternatively, the fantasy sports contest application may assign a low value (e.g., D) corresponding to path code 1608 in order to minimize the probability of showing the same advertisement to the same user multiple times during a single visit.

Advertisement record 1602 may further include attribute exit code 1610 to indicate an advertisement's tendency to cause a user to exit the contest system. For example, the fantasy sports contest application may assign a high value corresponding to exit code 1610 for an advertisement that attracts a significant level of interest and requires the fantasy sports contest application to route the user to an external location (e.g., an Internet location). In this example, the fantasy sports contest application has assigned a low value to advertisement “Shag Attaq,” signifying that the advertisement does not require routing or have a tendency to induce the user to exit the fantasy sports contest application.

Contest screen record 1630 includes attributes and values similar to those discussed above in connection with advertisement record 1602. In this example, contest screen record 1630 includes information associated with the login screen. Values associated with request code 1604 and duration code 1606 indicate that the login screen has a high view frequence and a short average view duration. Value corresponding to path code 1608 signifies a close association with other contest screens in one or more paths. The record further shows a low value (e.g., D) associated with exit code 1610, indicating a low tendency for the user to exit the from the login screen.

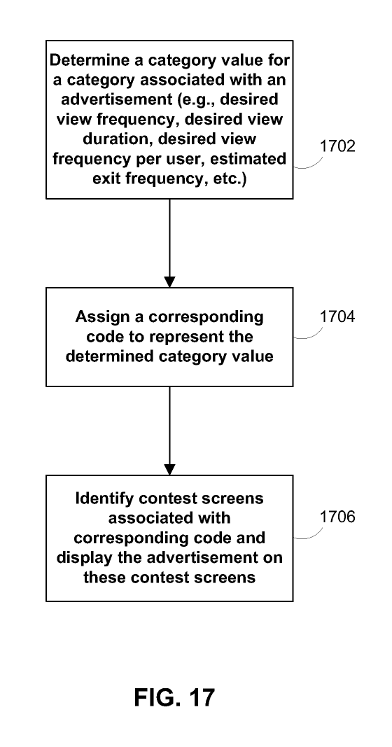

FIG. 17 shows a flow chart of illustrative steps involved in matching advertisement to contest screens based on various categorization codes in accordance with one embodiment of the present invention.

At step 1702, the system may determine a value for a particular category associated with an advertisement (e.g., desired view frequency, desired view duration, desired view frequency in paths, actual or estimated exit frequence, or any other suitable category value). For example, the value for a category (e.g., desired view frequency) may be supplied by the advertiser in absolute numbers (e.g., 500 views per day), relatively levels (e.g., high), or any other suitable representation of such information. As another example, the fantasy sports contest application may analyze the advertisement and determine the appropriate value for the category of characteristics as an additional service.

Upon determining the value, the fantasy sports contest application may subsequently assign appropriate level code (e.g., A-D) to the category. For example, the fantasy sports contest application may compare measurements (e.g., 500 views per day) submitted by the advertiser to a set of pre-defined levels (e.g., 400 and above is A) corresponding to the category in order to determine suitable level to be stored in connection with the advertisement in a database record (database record 1602 of FIG. 16).

At step 1606, the fantasy sports contest application may identify fantasy sports contest screens with corresponding category code and display the advertisement on the identified screens.

The fantasy sports contest application may match advertisements to contest screens at various times and locations depending on the chosen implementation. For example, the fantasy sports contest application may perform a periodical search (e.g., once a day, once a week, etc) to find corresponding advertisements and contest screens in, for example, user television equipment 224 (FIG. 2) where such data may be temporarily stored, television distribution facility 210 (FIG. 2), main facility (202), or any other suitable locations.

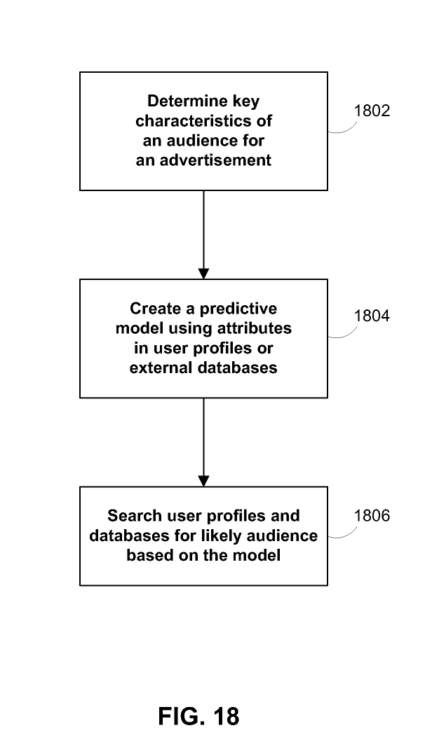

FIG. 18 shows a flow chart of illustrative steps involved in predicting receptive audiences for an advertisement in accordance with one embodiment of the present invention. At step 1802, the fantasy sports contest application may determine a set of key characteristics associated with an ideal audience for a particular advertisement (e.g., new residents are good target customers for laundry services). As an example, the fantasy sports contest application may receive such information directly from an advertiser. As another example, the fantasy sports contest application may adopt audience characteristics of similar advertisements.

At step 1804, the fantasy sports contest application may create a predictive model that may match or infer the key characteristics determined at step 1802 using attributes in user profiles and/or attributes in external databases associated with the user. For example, the fantasy sports contest application may create a predictive model to search for people who have recently moved because the attribute suggest such users may be looking for local laundry service.

At step 1806, the fantasy sports contest application may search user profiles and external databases based on the predictive model to identify a receptive audience for the advertisement.

Thus, systems and methods for integrating data mining and other marketing techniques in fantasy sports contest applications and other contest applications to provide personalized advertisements and other marketing-related content are provided. One skilled in the art will appreciate that the present invention can be practiced by other than the described embodiments, which are presented for purposes of illustration and not of limitation, and the present invention is limited only by the claims which follow.

1-17. (canceled)

18. A method for targeting advertisements to a user of a fantasy sports contest application implemented by processing circuitry in communication with a user input device and a user output device, the user being associated with a user cluster, the method comprising:
selecting, by the processing circuitry, an attribute of a contest taking place in the fantasy sports contest application, wherein the user is a contestant in the contest;
determining, by the processing circuitry, at least one popular advertisement associated with the attribute, wherein the at least one popular advertisement is frequently viewed by users in the user cluster;
determining, by the processing circuitry, whether the user has been exposed to the advertisement; and
in response to determining that the user has not been exposed to the advertisement, displaying on the user output device the at least one popular advertisement to which the user has not been exposed using the fantasy sports contest application.

19. The method of claim 18, further comprising scheduling to display the at least one popular advertisement to the user using the fantasy sports contest application at a particular time, wherein displaying the at least one popular advertisement occurs at the particular time.

20. The method of claim 18, wherein determining the at least one popular advertisement in the user cluster comprises determining a high level of interest in the at least one popular advertisement.

21. (canceled)

22. A method for acquiring information about a user of a fantasy sports contest application implemented by processing circuitry in communication with a user input device and a user output device, the method comprising:
generating, by the processing circuitry, for the user an option to play a predictive game, wherein the predictive game predicts a behavioral attribute of the user;
receiving from the user input device user input from playing the predictive game;
predicting, by the processing circuitry, the behavioral attribute for the user based on the user input and a user attribute specified in a user profile associated with the user; and
automatically modifying, by the processing circuitry, the user profile associated with the user based on the behavioral attribute predicted by the predictive game.

23. The method of claim 22, wherein modifying the user profile comprises processing the user input to confirm at least a portion of the user profile.

24. A method for targeting advertisements to a user of a fantasy sports contest application implemented by processing circuitry in communication with a user input device and a user output device, the method comprising:
receiving from the user input device a user request for fantasy sports contest information, wherein the fantasy sports contest information comprises information associated with a contest element;
identifying, by the processing circuitry, at least one advertisement associated with the contest element and with a user cluster associated with the user; and
simultaneously displaying on the user output device the fantasy sports contest information and the at least one advertisement to the user.

25. The method of claim 24, further comprising:
identifying at least one additional advertisement associated with the at least one advertisement;
receiving a user command to select one of the at least one advertisement; and
displaying at least one of the at least one additional advertisement in response to receiving the user command to select the one of the at least one advertisement.

26-47. (canceled)

48. A system for targeting advertisements to a user of a fantasy sports contest application, the user being associated with a user cluster, the system comprising:
means for selecting an attribute of a contest taking place in the fantasy sports contest application, wherein the user is a contestant in the contest;
means for determining at least one popular advertisements associated with the attribute, wherein the at least one popular advertisement is frequently viewed by users in the user cluster;
means for determining whether the user has been exposed to the advertisement; and
means for displaying the at least one popular advertisement to which the user has not been exposed using the fantasy sports contest application, in response to determining that the user has not been exposed to the advertisement.

49. The system of claim 48, further comprising means for scheduling to display the at least one popular advertisement to the user using the fantasy sports contest application at a particular time, wherein the means for displaying the at least one popular advertisement is configured to occur at the particular time.

50. The system of claim 48, wherein the means for determining the at least one popular advertisement in the user cluster comprises means for determining a high level of interest in the at least one popular advertisement.

51. (canceled)

52. A system for acquiring information about a user of a fantasy sports contest application, the system comprising:
means for generating for the user with an option to play a predictive game, wherein the predictive game predicts a behavioral attribute of the user;
means for receiving user input from playing the predictive game;
means for predicting the behavioral attribute for the user based on the user input and a user attribute specified in a user profile associated with the user; and
means for automatically modifying the user profile associated with the user based on the behavioral attribute predicted by the predictive game.

53. The system of claim 52, wherein the means for modifying the user profile comprises means for processing the user input to confirm at least a portion of the user profile.

54. A system for targeting advertisements to a user of a fantasy sports contest application, the system comprising:
means for receiving a user request for fantasy sports contest information, wherein the fantasy sports contest information comprises information associated with a contest element;
means for identifying at least one advertisement associated with the contest element and with a cluster associated with the user; and
means for simultaneously displaying the fantasy sports contest information and the at least one advertisement to the user.

55. The system of claim 54, further comprising:
means for identifying at least one additional advertisement associated with the at least one advertisement;
means for receiving a user command to select one of the at least one advertisement; and
means for displaying at least one of the at least one additional advertisement in response to receiving the user command to select the one of the at least one advertisement.

56-77. (canceled)

78. A system for targeting advertisements to a user of a fantasy sports contest application, the user being associated with a user cluster, the system comprising a computer processor configured to:
select an attribute of a contest taking place in the fantasy sports contest application, wherein the user is a contestant in the contest;
determine at least one popular advertisement associated with the attribute, wherein the at least one popular advertisement is frequently viewed by users in the user cluster;
determine whether the user has been exposed to the advertisement; and
display on a user output device the at least one popular advertisement to which the user has not been exposed using the fantasy sports contest application in response to determining that the user has not been exposed to the advertisement.

79. The system of claim 78, wherein the computer processor is further configured to:
schedule to display on the user output device the at least one popular advertisement to the user using the fantasy sports contest application at a particular time, and
display on the user output device the at least one popular advertisement to the user at the particular time.

80. The system of claim 78, wherein the computer processor is configured to determine a high level of interest in the at least one popular advertisement.

81. (canceled)

82. A system for acquiring information about a user of a fantasy sports contest application, the system comprising a computer processor configured to:
generate for the user with an option to play a predictive game, wherein the predictive game predicts a behavioral attribute of the user;
receive from a user input device user input from playing the predictive game;
predict the behavioral attribute for the user based on the user input and a user attribute specified in a user profile associated with the user; and
automatically modify the user profile associated with the user based on the behavioral attribute predicted by the predictive game.

83. The system of claim 82, wherein the computer processor is configured to process the user input to confirm at least a portion of the user profile.

84. A system for targeting advertisements to a user of a fantasy sports contest application, the system comprising:
a user output device comprising a display device; and
a computer processor configured to:
receive from a user input device a user request for fantasy sports contest information, wherein the fantasy sports contest information comprises information associated with a contest element;
identify at least one advertisement associated with the contest element and with a user cluster associated with the user; and
simultaneously display on the user output device the fantasy sports contest information and the at least one advertisement to the user.

85. The system of claim 84, wherein the computer processor is further configured to:
identify at least one additional advertisement associated with the at least one advertisement;
receive from the user input device a user command to select one of the at least one advertisement; and
display on the user output device at least of the at least one additional advertisement in response to receiving the user command to select the one of the at least one advertisement.

86-107. (canceled)

108. Machine-readable media for targeting advertisements to a user of a fantasy sports contest application, the user being associated with a user cluster, wherein the machine-readable media is encoded with machine-readable instructions for performing the method comprising:
selecting an attribute of a contest taking place in the fantasy sports contest application, wherein the user is a contestant in the contest;
determining at least one popular advertisement associated with the attribute, wherein the at least one popular advertisement is frequently viewed by users in the user cluster;
determining whether the user has been exposed to the advertisement; and
in response to determining that the user has not been exposed to the advertisement, displaying the at least one popular advertisement to which the user has not been exposed using the fantasy sports contest application.

109. The machine-readable media of claim 108, further comprising scheduling to display the at least one popular advertisement to the user using the fantasy sports contest application at a particular time, wherein displaying the at least one popular advertisement occurs at the particular time.

110. The machine-readable media of claim 108, wherein determining the at least one popular advertisement in the user cluster comprises determining a high level of interest in the at least one popular advertisement.

111. (canceled)

112. Machine-readable media for acquiring information about a user of a fantasy sports contest application, wherein the machine-readable media is encoded with machine-readable instructions for performing the method comprising:
generating for the user with an option to play a predictive game, wherein the predictive game predicts a behavioral attribute of the user;
receiving user input from playing the predictive game;
predicting the behavioral attribute for the user based on the user input and a user attribute specified in a user profile associated with the user; and
automatically modifying the user profile associated with the user based on the behavioral attribute predicted by the predictive game.

113. The machine-readable media of claim 112, wherein modifying the user profile comprises processing the user input to confirm at least a portion of the user profile.

114. Machine-readable media for targeting advertisements to a user of a fantasy sports contest application, wherein the machine-readable media is encoded with machine-readable instructions for performing the method comprising:
receiving a user request for fantasy sports contest information, wherein the fantasy sports contest information comprises information associated with a contest element;
identifying at least one advertisement associated with the contest element and with a user cluster associated with the user; and
simultaneously displaying the fantasy sports contest information and the at least one advertisement to the user.

115. The machine-readable media of claim 114, further comprising:
identifying at least one additional advertisement associated with the at least one advertisement;
receiving a user command to select one of the at least one advertisement; and
displaying at least one of the at least one additional advertisement in response to receiving the user command to select the one of the at least one advertisement.

116-120. (canceled)

121. The method of claim 22, further comprising displaying the behavioral attribute predicted by the predictive game on a user output device.
